(19) United States
(12) Patent Application Publication
(10) Pub. No.: US 2002/0049571 A1
(43) Pub. Date: Apr. 25, 2002

(54) Supportability evaluation of system architectures

(76) Inventors: Dinesh Verma, Manassas, VA (US); Robert McCaig, Manassas, VA (US); Line Holm Johannessen, Kongsberg (NO)

Correspondence Address: VENABLE, BAETJER, HOWARD AND CIVILETTI, LLP, P.O. BOX 34385, WASHINGTON, DC, 20043-9998, US

(21) Appl. No.: 09/864,302

(22) Filed: May 25, 2001

Related U.S. Application Data
(60) Provisional application No. 60/207,156, filed on May 25, 2000.

(51) Int. Cl. G06F 17/50

(52) U.S. Cl. 703/1

(57) ABSTRACT

A system, method and computer program product is disclosed for evaluating system architectures from a long term sustainability perspective, sustainability in the presence of rapidly evolving information and networking technology, rapidly evolving customer requirements and expectations, and rapidly evolving standards and protocols. The multi-attribute architecture evaluation method can include specific architectural characteristics. At the top level the present invention can include four architectural characteristics or attributes: modularity, commonality, standards-based, and reliability/maintainability/testability (RMT). The attributes can be further classified into sub-attributes and metrics to facilitate the comparative evaluation of candidate system architectures. In an exemplary embodiment of the present invention a decision support system, method and CPP for evaluating supportability of alternative system architecture designs is disclosed including: an analytic hierarchy process (AHP) model including a plurality of attributes, wherein the plurality of attributes includes: a commonality attribute; a modularity sub-attribute; a standards based sub-attribute; and a RMT sub-attribute. The present invention in an exemplary implementation can be embedded within a commercially available AHP shell, to facilitate adaptation to specific domains.

### CROSS-REFERENCE TO RELATED APPLICATION

The present application claims priority to and is related to U.S. Provisional Patent Application No. 60/207,156, Confirmation No.______, (Attorney Docket No. 36994-167671, formerly FE-00496) filed May, 25, 2000 entitled “Supportability Evaluation of System Architecture” to Johannesen et al., of common assignee to the present invention, the contents of which are incorporated herein by reference in their entirety.

### BACKGROUND OF THE INVENTION

1. Field of the Invention

The present invention relates generally to a methodology for evaluating system architectures, and more particularly to a methodology for evaluating system architectures from a perspective in an environment characterized by imprecise information with regard to information technology evolution and customer requirements and expectations.

2. Related Art

The domain of systems engineering has been characterized by accelerating interest in the past two decades. The design phase of the system life cycle is finally being recognized for its potential impact on the development of truly efficient and effective products, systems, and structures that more closely track customer requirements and needs. This recognition, in addition to increasing budget restrictions, have lead to the development of concepts such as integrated process and product development (IPPD), modernization through spares, application of commercial-off-the-shelf (COTS) technologies and the application of cost as an independent variable.

Studies within the United States Department of Defense suggest an increasing allocation of defense budgets are related to operating and sustaining legacy systems. The costs of maintaining legacy systems inhibits the ability to develop new weapons systems or to upgrade and modernize legacy combat systems.

Today, there is a demand for bolder and more rapid improvements in the total cost of system ownership. As such, the technical risks faced by the designer are now greater, as are the stakes. These result, not only from an on-going reduction in available resources, but also because of changing requirements driven by changing missions (e.g., from missions in deep blue waters to missions in littoral shallow waters), changing threats, and the trend towards joint, multiple nation, operations.

In order to facilitate the realization of radical reductions in the cost of system acquisition and operation, the system design process is facing increasing scrutiny resulting in the formulation of concepts such as the integrated product and process development (IPPD). This approach is analogous to concurrency in system engineering.

The consideration of three concurrent life cycles as part of the overall system engineering process has been suggested, described further with reference to FIG. 2A below. The first of the three concurrent life cycles track design and development of the primary product from conceptual and preliminary development, on through detailed engineering and development, on through production and deployment, and through to utilization and phase-out. The second of the three concurrent life cycles covers design, development, and installation of production infrastructure and operations. The third of the three concurrent lifecycles includes design, development, and deployment of a maintenance and support infrastructure and operations capability for the deployed product and the manufacturing facility. This concurrency or “totality” during system design makes design more rigorous, comprehensive, and complex.

The fundamental thesis of the IPPD process is that a structured, disciplined, and properly managed, systems engineering process is essential for the successful development of effective systems. Systems engineering as referred to herein is defined as the application and efforts to:

1. transform an operational need into description of system performance parameters and a preferred system configuration through the use of an iterative process of functional analysis, synthesis, optimization, definition, design, test, and evaluation;

2. incorporate related technical parameters and assure compatibility of physical, functional, and program interfaces in a manner that optimizes the total definition and design; and

3. integrate performance, producibility, reliability, maintainability, manageability, supportability, and other specialties into the overall engineering effort.

The system life cycle begins with the identification of a functional need or operational deficiency. More often than not, system operational deficiency can be articulated in terms of the cost of system ownership, rather than any particular prime mission performance parameter or attribute.

The operational deficiency is translated into a system level requirements definition process through the utilization of tools such as quality function deployment and input-output matrices.

The requirements definition process is then followed by the conceptual design phase (involving the synthesis and selection of system-level conceptual solutions).

The preliminary design phase (involving the modeling of expected system behavior, the allocation of system level requirements to conceptual sub-systems, and their subsequent translation into detailed design specifications) follows the conceptual design phase. The system architecture, depicting the functional, operational, and physical packaging of the selected approach of system concept is developed during the preliminary design phase.

Preliminary design is followed by detailed design and development.

Following detailed design and development, actual production and/or construction of the product or structure can occur.

The product or structure is then deployed, installed, operated, and maintained. At the end of this operational (design) or economic life, the entity is either re-engineered to satisfy an evolving need or requirement, or properly retired or recycled.

What is needed is to establish systems, methods, and computer program products that allow the assessment of the supportability of system design during all the systems engineering phases, with a particular emphasis on conceptual and preliminary design phases.

### SUMMARY OF THE INVENTION

In an exemplary embodiment of the present invention a system, method and computer program product for evaluating system architectures from the perspective of robustness, scalability, and upgradeability is disclosed.

In an exemplary embodiment of the present invention a decision support system for evaluating supportability of alternative system architecture designs is disclosed including: an analytic hierarchy process (AHP) model including a plurality of attributes, wherein the plurality of attributes includes: a commonality attribute; a modularity sub-attribute; a standards based sub-attribute; and a reliability, maintainability, testability (RMT) sub-attribute.

In one exemplary embodiment, the commonality attribute includes: a plurality of sub-attributes of the commonality attribute, the plurality of sub-attributes of the commonality attribute including at least one of: a physical commonality sub-attribute; a physical familiarity sub-attribute; and an operational commonality sub-attribute.

In one exemplary embodiment, the physical commonality sub-attribute further includes: a plurality of sub-attributes of the physical commonality sub-attribute, the plurality of sub-attributes of the physical commonality sub-attribute including at least one of: a hardware (HW) commonality sub-attribute; and a software (SW) commonality sub-attribute.

In one exemplary embodiment, the hardware commonality sub-attribute includes: a plurality of sub-attributes of the hardware commonality sub-attribute, the plurality of sub-attributes of the hardware commonality sub-attribute including at least one of: a number of unique lowest replaceable units (LRUs) sub-attribute; a number of unique fasteners sub-attribute; a number of unique cables sub-attribute; and a number of unique standards Implemented sub-attribute.

In one exemplary embodiment, the software commonality sub-attribute includes: a plurality of sub-attributes of the software commonality sub-attribute, the plurality of sub-attributes of the software commonality sub-attribute including at least one of: a number of unique SW packages implemented sub-attribute; a number of languages sub-attribute; a number of compilers sub-attribute; a average number of SW instantiations sub-attribute; and a number of unique standards implemented sub-attribute.

In one exemplary embodiment, the physical familiarity sub-attribute includes: a plurality of sub-attributes of the physical familiarity sub-attribute, the plurality of sub-attributes of the physical familiarity sub-attribute including at least one of: a percentage vendors known sub-attribute; a percentage subcontractors known sub-attribute; a percentage HW technology known sub-attribute; and a percentage SW technology known sub-attribute.

In one exemplary embodiment, the operational commonality sub-attribute includes: a plurality of sub-attributes of the operational commonality sub-attribute, the plurality of sub-attributes of the operational commonality sub-attribute including at least one of: a percentage of operational functions automated sub-attribute; a number of unique skill codes required sub-attribute; an estimated operational training time—initial sub-attribute; an estimated operational training time—refresh from previous system sub-attribute; an estimated maintenance training time—initial sub-attribute; and an estimated maintenance training time—refresh from previous system sub-attribute.

In one exemplary embodiment, the modularity attribute includes: a plurality of sub-attributes of the modularity attribute, the plurality of sub-attributes of the modularity attribute including at least one of: a physical modularity sub-attribute; a functional modularity sub-attribute; an orthogonality sub-attribute; an abstraction sub-attribute; and an interfaces sub-attribute.

In one exemplary embodiment, the physical modularity sub-attribute includes: a plurality of sub-attributes of the physical modularity sub-attribute, the plurality of sub-attributes of the physical modularity sub-attribute including at least one of: an ease of system element upgrade sub-attribute; and an ease of operating system element upgrade sub-attribute.

In one exemplary embodiment, the ease of system element upgrade sub-attribute includes: a plurality of sub-attributes of the ease of system element upgrade sub-attribute, the plurality of sub-attributes of the ease of system element upgrade sub-attribute including at least one of: a lines of modified code sub-attribute; and an amount of labor hours for system rework sub-attribute.

In one exemplary embodiment, the ease of operating system element upgrade sub-attribute includes: a plurality of sub-attributes of the ease of operating system element upgrade sub-attribute, the plurality of sub-attributes of the ease of operating system element upgrade sub-attribute including at least one of: a lines of modified code sub-attribute; and an amount of labor hours for system rework sub-attribute.

In one exemplary embodiment, the functional modularity sub-attribute further includes: a plurality of sub-attributes of the functional modularity sub-attribute, the plurality of sub-attributes of the functional modularity sub-attribute including at least one of: an ease of adding new functionality sub-attribute; and an ease of upgrade existing functionality sub-attribute.

In one exemplary embodiment, the ease of adding new functionality sub-attribute further includes: a plurality of sub-attributes of the ease of adding new functionality sub-attribute, the plurality of sub-attributes of the ease of adding new functionality sub-attribute including at least one of: a lines of modified code sub-attribute; and an amount of labor hours for system rework sub-attribute.

In one exemplary embodiment, the ease of upgrading existing functionality sub-attribute, the plurality of sub-attributes includes: a plurality of sub-attributes of the ease of upgrading existing functionality sub-attribute, the plurality of sub-attributes of the ease of upgrading existing functionality sub-attribute including at least one of: a lines of modified code sub-attribute; and an amount of labor hours for system rework sub-attribute.

In one exemplary embodiment, the orthogonality sub-attribute includes: a plurality of sub-attributes of the orthogonality sub-attribute, the plurality of sub-attributes of the orthogonality sub-attribute including at least one of: a determination of whether functional requirements are fragmented across multiple processing elements and interfaces sub-attribute; a determination of whether there are throughput requirements across interfaces sub-attribute; and a determination of whether common specifications are identified sub-attribute.

In one exemplary embodiment, the abstraction sub-attribute includes: a plurality of sub-attributes of the abstraction sub-attribute, the plurality of sub-attributes of the abstraction sub-attribute including at least one of: a determination of whether the system architecture provides an option for information hiding sub-attribute.

In one exemplary embodiment, the interfaces sub-attribute includes: a plurality of sub-attributes of the interfaces sub-attribute, the plurality of sub-attributes of the interfaces sub-attribute including at least one of: a number of unique interfaces per system element sub-attribute; a number of different networking protocols sub-attribute; an explicit versus implicit interfaces sub-attribute; a determination of whether the architecture involves implicit interfaces sub-attribute; and a number of cables in the system sub-attribute.

In one exemplary embodiment, the AHP structure further includes: a plurality of sub-attributes of the standards based attribute, the plurality of sub-attributes of the standards based attribute including at least one of: an open systems orientation sub-attribute; and a consistency orientation sub-attribute.

In one exemplary embodiment, the open systems orientation sub-attribute includes: a plurality of sub-attributes of the open systems orientation sub-attribute, the plurality of sub-attributes of the open systems orientation sub-attribute including at least one of: an interface standards sub-attribute; a HW standards sub-attribute; and a software standards sub-attribute.

In one exemplary embodiment, the interface standards sub-attribute includes: a plurality of sub-attributes of the interface standards sub-attribute, the plurality of sub-attributes of the interface standards sub-attribute including at least one of: a number of interface standards/number and number of Interfaces sub-attribute; a determination of multiple vendors (greater than 5) existing for products based on standards sub-attribute; a multiple business domains apply/use standard (Aerospace, Medical, Telecommunications) sub-attribute; and a standard maturity sub-attribute.

In one exemplary embodiment, the hardware standards sub-attribute includes: a plurality of sub-attributes of the hardware standards sub-attribute, the plurality of sub-attributes of the hardware standards sub-attribute including at least one of: a number of form factors and number of LRUs sub-attribute; a multiple vendors (greater than 5) exist for a products based on standards sub-attribute; a multiple business domains apply/use standard (aerospace, medical, telecommunications) sub-attribute; and a standard maturity sub-attribute.

In one exemplary embodiment, the software standards sub-attribute includes: a plurality of sub-attributes of the software standards sub-attribute, the plurality of sub-attributes of the software standards sub-attribute including at least one of: a number of proprietary & unique operating systems sub-attribute; a number of non-std databases sub-attribute; a number of proprietary middle-ware sub-attribute; and a number of non-std languages sub-attribute.

In one exemplary embodiment, the consistency orientation sub-attribute includes: a plurality of sub-attributes of the consistency orientation sub-attribute, the plurality of sub-attributes of the consistency orientation sub-attribute including at least one of: common guidelines for implementing diagnostics and performance monitoring/fault localization (PM/FL) sub-attribute; and common guidelines for implementing operator machine interface (OMI) sub-attribute.

In one exemplary embodiment, the RMT attribute includes: a plurality of sub-attributes of the RMT attribute, the plurality of sub-attributes of the RMT attribute including at least one of: a reliability sub-attribute; a maintainability sub-attribute; and a testability sub-attribute.

In one exemplary embodiment, the reliability sub-attribute includes: a plurality of sub-attributes of the reliability sub-attribute, the plurality of sub-attributes of the reliability sub-attribute including at least one of: a fault tolerance sub-attribute; and a critical points of delicateness (system loading) sub-attribute.

In one exemplary embodiment, the fault tolerance sub-attribute includes: a plurality of sub-attributes of the fault tolerance sub-attribute, the plurality of sub-attributes of the fault tolerance sub-attribute including at least one of: a percentage of mission critical functions with single points of failure sub-attribute; and a percentage of safety critical functions with single points of failure sub-attribute.

In one exemplary embodiment, the critical points of delicateness (system loading) sub-attribute further includes: a plurality of sub-attributes of the critical points of delicateness (system loading) sub-attribute, the plurality of sub-attributes of the critical points of delicateness (system loading) sub-attribute including at least one of: a percentage of processor loading sub-attribute; a percentage of memory loading sub-attribute; and a percentage of network loading sub-attribute.

In one exemplary embodiment, the percentage memory loading sub-attribute includes a criticality assessment sub-attribute of the percentage memory loading sub-attribute.

In one exemplary embodiment, the percentage network loading sub-attribute includes a criticality assessment sub-attribute of the percentage network loading sub-attribute.

In one exemplary embodiment, the maintainability sub-attribute includes: a plurality of sub-attributes of the maintainability sub-attribute, the plurality of sub-attributes of the maintainability sub-attribute including at least one of: an expected MTTR sub-attribute; a maximum fault group size sub-attribute; a determination of whether system is operational during maintenance sub-attribute; and an accessibility sub-attribute.

In one exemplary embodiment, the accessibility sub-attribute further includes: a plurality of sub-attributes of the accessibility sub-attribute, the plurality of sub-attributes of the accessibility sub-attribute including at least one of: a space restrictions determination sub-attribute; a special tool requirements determination sub-attribute; and a special skill requirements determination sub-attribute.

In one exemplary embodiment, the testability sub-attribute includes: a plurality of sub-attributes of the testability sub-attribute, the plurality of sub-attributes of the testability sub-attribute including at least one of: a BIT Coverage sub-attribute; an error reproducibility sub-attribute; an online testing sub-attribute; and an automated input/stimulation insertion sub-attribute.

In one exemplary embodiment, the error reproducability sub-attribute includes: a plurality of sub-attributes of the error reproducability sub-attribute, the plurality of sub-attributes of the error reproducability sub-attribute including at least one of: a logging/recording capability sub-attribute; and a determination of whether system state at time of system failure can be created sub-attribute.

In one exemplary embodiment, the online testing sub-attribute includes: a plurality of sub-attributes of the online testing sub-attribute, the plurality of sub-attributes of the online testing sub-attribute including at least one of: a determination of whether system is operational during external testing sub-attribute; and an ease of access to external testpoints sub-attribute.

In another exemplary embodiment of the present invention a decision support system for evaluating the supportability of alternative system architecture designs is disclosed including:

means for assigning relative weights to each attribute and sub-attribute of a plurality of attributes and sub-attributes of an analytical hierarchy process (AHP) model wherein the plurality of attributes includes: a commonality attribute, a modularity attribute, a standards based attribute, and a reliability, maintainability, and testability (RMT) attribute, including: means for performing pair-wise comparisons of the plurality of attributes and sub-attributes at all levels of the AHP model, and means for assigning relative weights to all of the attributes and sub-attributes at all levels of the AHP model; means for generating a GPW for each of a plurality of alternative system architecture designs including: means for performing pair-wise comparisons of each of the plurality of alternative system architecture designs with respect to the all of the attributes and sub-attributes at all levels of the AHP model; and means for evaluating the plurality of alternative system architecture designs from a supportability perspective including comparing values of the GPWs of the plurality of alternative system architecture designs.

In yet another exemplary embodiment of the present invention a decision support system that determines global priority weights (GPWs) of alternative system architecture designs including: an analytic hierarchy process engine operative to compare a plurality of relative priority attribute weights to generate the GPW of each of the alternative system architecture designs wherein the relative priority attribute weights correspond to a plurality of attributes; and operative to compare a plurality of relative priority sub-attribute weights to generate each of the plurality of relative priority attribute weights wherein the relative priority sub-attribute weights correspond to a plurality of sub-attributes; wherein the plurality of attributes includes a commonality attribute; a modularity attribute; a standards based attribute; and a reliability, maintainability, and testability (RMT) attribute.

In another exemplary embodiment of the present invention a method for evaluating the supportability of alternative system architecture designs is disclosed including the steps of: (a) assigning relative weights to each attribute and sub-attribute of a plurality of attributes and sub-attributes of an analytical hierarchy process (AHP) model wherein the plurality of attributes includes: a commonality attribute, a modularity attribute, a standards based attribute, and a reliability, maintainability, and testability (RMT) attribute, including: (1) performing pair-wise comparisons of the plurality of attributes and sub-attributes at all levels of the AHP model, and (2) assigning relative weights to all of the attributes and sub-attributes at all levels of the AHP model; (b) generating a GPW for each of a plurality of alternative system architecture designs including: (1) performing pair-wise comparisons of each of the plurality of alternative system architecture designs with respect to the all of the attributes and sub-attributes at all levels of the AHP model; and (c) evaluating the plurality of alternative system architecture designs from a supportability perspective including comparing values of the GPWs of the plurality of alternative system architecture designs.

In one exemplary embodiment, the step (a) further includes: (3) performing sensitivity analysis of the pair-wise comparisons.

In yet another exemplary embodiment of the present invention a computer program product (CPP) for evaluating system architecture designs using an analytic hierarchy process (AHP) model, the CPP embodied on a computer readable medium having program logic stored therein, including: means for enabling a processor to assign relative weights to each attribute and sub-attribute of a plurality of attributes and sub-attributes of an analytical hierarchy process (AHP) model wherein the plurality of attributes includes: a commonality attribute, a modularity attribute, a standards based attribute, and a reliability, maintainability, and testability (RMT) attribute, including: means for enabling the processor to perform pair-wise comparisons of DOTs the plurality of attributes and sub-attributes at all levels of the AHP model, and means for enabling the processor to assign relative weights to all of the attributes and sub-attributes at all levels of the AHP model; means for enabling the processor to generate a GPW for each of a plurality of alternative system architecture designs including: means for enabling the computer to perform pair-wise comparisons of each of the plurality of alternative system architecture designs with respect to the all of the attributes and sub-attributes at all levels of the AHP model; and

means for enabling the computer to evaluate the plurality of alternative system architecture designs from a supportability perspective including comparing values of the GPWs of the plurality of alternative system architecture designs.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements. The left most digits in the corresponding reference number indicate the drawing in which an element first appears.

FIG. 1 depicts a table illustrating an exemplary embodiment of a design for supportability and upgradeability hierarchy of attributes according to the present invention;

FIG. 2A depicts a block diagram of an exemplary embodiment of a systems engineering process according to the present invention;

FIG. 2B depicts an exemplary embodiment of a chart illustrating costs incurred by a program over the systems engineering process life cycle according to the present invention;

FIG. 2C depicts an exemplary embodiment of a a more detailed example of the systems engineering process of FIG. 2A according to the present invention;

FIG. 3 depicts an exemplary embodiment of a block diagram illustrating a modular system according to the present invention;

FIG. 4 depicts an exemplary embodiment of a hierarchy of a goal and exemplary multiple levels of attributes and sub-attributes according to the present invention;

FIG. 5 depicts an exemplary embodiment of a design for supportability and upgradeability analytical hierarchy according to the present invention;

FIG. 6A depicts an exemplary embodiment of a graphical user interface (GUI) of an exemplary implementation embodiment of a supportability evaluation of system architectures decision support system with illustrative attributes and sub-attributes according to the present invention;

FIG. 6B depicts an exemplary embodiment a GUI of an exemplary implementation embodiment of a supportability evaluation of system architectures decision support system with a selected modular attribute and depicting sub-attributes of the modular attribute and nested additional sub-attributes of the sub-attributes according to the present invention; and

FIG. 6C depicts an exemplary embodiment a GUI of an exemplary implementation embodiment of a supportability evaluation of system architectures decision support system with a selected reliability, maintainability and testability (RMT) attribute and depicting sub-attributes of the RMT attribute and nested additional sub-attributes of the sub-attributes according to the present invention.

### DETAILED DESCRIPTION OF AN EXEMPLARY EMBODIMENT OF THE PRESENT INVENTION

A preferred embodiment of the invention is discussed in detail below. While specific exemplary embodiments are discussed, it should be understood that this is done for illustration purposes only. A person skilled in the relevant art will recognize that other components and configurations can be used without parting from the spirit and scope of the invention.

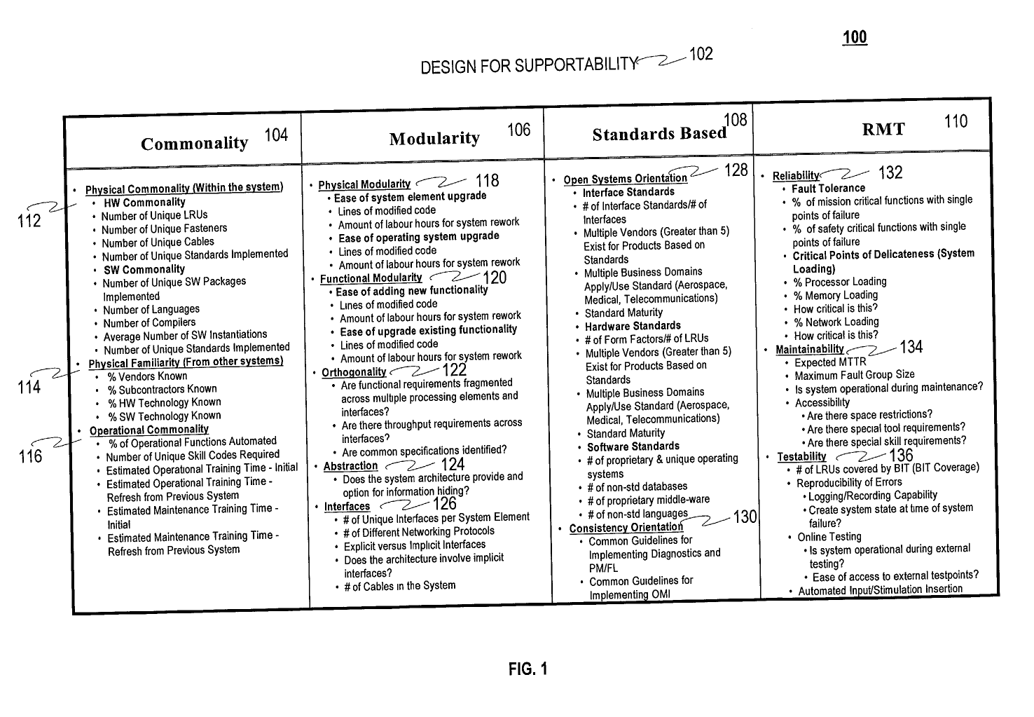

FIG. 1 depicts a table 100 illustrating an exemplary embodiment of a design for supportability and upgradeability analytic hierarchy process (AHP) model 102 including various exemplary attributes 104-110. AHP model 102 includes, in an exemplary embodiment, a commonality attribute 104, a modularity attribute 106, a standards based attribute 108 and a reliability, maintainability, and testability (RMT) attribute 110 of the present invention.

Commonality attribute 104 is shown in an exemplary embodiment including various sub-attributes 112-116. In particular, commonality attribute 104 includes, in an exemplary embodiment, a physical commonality sub-attribute 112, a physical familiarity sub-attribute 114, and an operational commonality sub-attribute 116. As depicted, in an exemplary embodiment, each sub-attribute 112-116 can in turn have various sub-attributes associated with the sub-attribute 112-116. For example, physical commonality sub-attribute 112 is shown having a hardware (HW) sub-attribute and a software (SW) sub-attribute (not labeled).

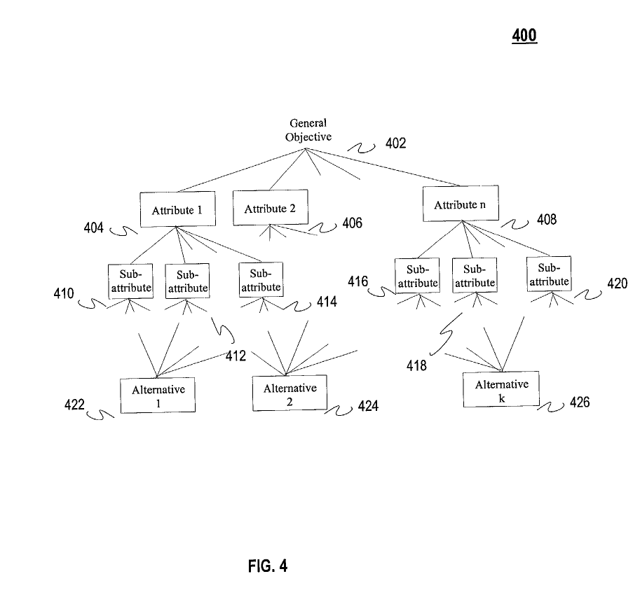

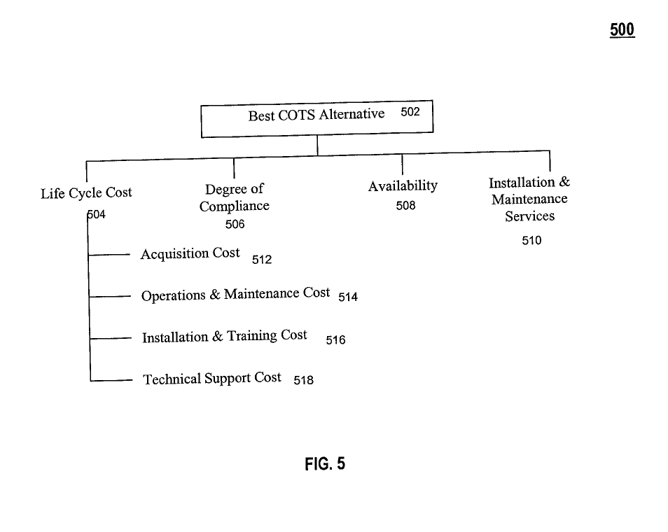

For an overview of the analytic hierarchy process (AHP) the reader is directed to the description with reference to FIGS. 4 and 5 below.

The Design for Supportability AHP Model

The Design for Supportability AHP model features an AHP having four top-level attributes: commonality, modularity, standards-based, and RMT.

Commonality

In the context of this invention, commonality is defined as the use of common (and familiar) physical, functional, and operational elements within the system being designed and evaluated. As such, the focus of the commonality attribute is to reduce the total number of unique system elements to the extent possible.

Accordingly, to provide the necessary structure and logical breakdown, the commonality attribute has been further decomposed into the following sub-attributes: hardware commonality, and software commonality, (collectively referred to as physical commonality), physical familiarity, and operational commonality. The metrics associated with each of these sub-attributes are next identified and explained:

Hardware Commonality (Within the System)

The focus of the hardware commonality sub-attribute is on the hardware elements composed within the alternative architectures being proposed. The objective of this sub-attribute is to maximize the extent of hardware commonality within the system, as reflected in the metrics identified to assess and evaluate this sub-attribute. Only the key and critical issues are highlighted.

Number of Unique Lowest Replacable Units (LRUS)

The number of unique LRUs gives an indication of the extent to which hardware commonality is a focus during the selection of the hardware elements within the constituent sub-systems. LRUs are those units within a complex system for which spare parts are stocked.

Minimizing the number of unique LRUs has a significant impact on the subsequent supportability and logistics planning activities.

Number of Unique Fasteners

The number of unique fasteners indicates the extent to which HW elements have been mounted using different or similar fastening elements. This number has a potential impact on the total number of tools that might be required.

Number of Unique Cables

A similar explanation applies for “the number of unique cables” as it did for “the number of unique LRUs.”

Number of Unique Standards Implemented

Minimizing the number of unique hardware standards can potentially and positively impact the total number of form factors implemented within a system configuration. Doing so can further influence a reduction in the total number of LRUs, along with a potential reduction in maintenance procedures, failure diagnosis procedures, and trouble shooting procedures.

Software Commonality

The focus of the software commonality sub-attribute is on the software elements composed within the alternative architectures being proposed. The objective of this sub-attribute is to maximize the extent of commonality within the system, as reflected in the metrics identified to assess and evaluate this sub-attribute. Only the key and critical issues are highlighted.

Number of Unique SW Packages Implemented

In the context of this assessment, the objective is to reduce the total number of software packages implemented within an architecture, through finding opportunities for commonality. This assessment can be done at a number of levels within the system configuration, for example, CSCIs (Computer Software Configuration Items) or the constituent CSCs (Computer Software Component).

Number of Languages

A reduction in the number of languages used to implement the various software packages can have long-term impact with regard to the ease and affordability of software upgrade and maintenance.

Number of Compilers

The rational for this metric is the similar to the rationale for the number of languages metric above. A reduction in the number of unique compilers and other software support packages can impact the costs and skills associated with software maintenance and upgrade.

Number of SW Instantiations

This metric conveys insight into the number of times that a particular software package is used within a system. The metric also reflects an effort to exploit opportunities for common requirements and functions.

Number of Unique Standards Implemented

The rationale for this metric is the same as the rationale for the number of SW instantiations metric above.

Physical Familiarity (From Other Systems)

Physical (hardware and software) familiarity focuses not only on the system elements proposed within the architecture, but also on their sources and the representative technologies and standards. This metric reflects the risk associated with the implementation of an architecture. A high degree of familiarity with the technologies, standards, and vendors associated with an architecture might suggest reduced risk with regard to its ultimate implementation.

Percent Vendors Known

This metric reflects the degree of familiarity with the sources of the system elements (both hardware and software) contained within a proposed architecture. This metric assumes that the quality associated with the products from these vendors is known, along with their ability to respond to the committed schedules and lead times. This metric might also reflect a company's familiarity with vendor specific processes such as configuration management and product evolution, which are critical when dealing with COTS-intensive system architectures.

Percent Subcontractors Known

The rationale here is the same as the rationale for the percent vendors known metric above.

Percent HW Technology Known

This metric reflects familiarity with the technologies and standards associated with the hardware elements contained within the proposed system architecture.

Percent SW Technology Known

The rationale and objective for this metric is the same as the rationale for the percent HW technology known metric above.

Operational Commonality

The operational commonality metric focuses on the interface between the system and its “human” elements, or the installers, operators, and maintainers. Selected issues pertaining to functional commonality are also included within this sub-attribute.

Percentage of Operational Functions Automated

This metric provides insight into the extent to which the operational procedures are automated within the proposed architecture. The extent to which the operational procedures are automated has an obvious impact on the skill level and training requirements associated with the system.

Number of Unique Skill Codes Required

A low number of necessary unique skill codes is desirable within a system architecture. This metric reflects a certain degree of operational commonality and a reduction in required training, both operational and maintenance.

Estimated Operational Training Time—Initial

This metric reflects the training time required for a new operator or user of the system, and indirectly conveys the amount and extent of skills required to operate the system.

Estimated Operational Training Time—Refresh From Previous System

The estimated operational training time metric reflects the degree of commonality between the proposed architecture and similar system used in the past, allowing a reuse of existing skills and training capabilities.

Estimated Maintenance Training Time—Initial

This metric reflects the training time required for a new maintainer of the system, and indirectly conveys the amount and extent of skills required to maintain the system.

Estimated Maintenance Training Time—Refresh from Previous System

While this metric is similar to the immediately above metric, it also reflects the degree of commonality between the proposed architecture and similar system used in the past, allowing a reuse of existing maintenance skills and training capabilities. This metric provides insight into the operational familiarity associated with the proposed architecture.

Standards Based

The next attribute is standards based. In this regard, the assessment is two pronged at the top level. On the one hand, a focus on industry standards when evaluating alternative system architectures reflects their orientation towards and compliance with “open” and popular standards. On the other hand, an essential and desirable characteristic of a good architecture is consistency with regard to internal company standards and guidelines. This characteristic is discussed in more detail later in this section and can be a competitive discriminator.

Accordingly, there are two top-level sub-attributes: open systems orientation and consistency orientation. A further breakdown of these two sub-attributes and the associated metrics are now addressed.

Open Systems Orientation

The open systems orientation sub-attribute is further decomposed into: interface standards, hardware standards and software standards. These metrics are addressed next along with the associated metrics:

Interface Standards

Number of Interface Standards/Number of Interfaces

This metric provides insight into the number of times that an “open” interface standard is complied with across the total number of interfaces (assuming that an interface standard can be either “open” or proprietary). In this particular case, a lower number of different interface standards is desirable.

Multiple Vendors (Greater Than 5) Exist for Products Based on Standards

This metric provides insight into the popularity of the interface standards selected, their maturity, and whether they are still “alive”. A larger number of vendors is preferable and suggests multiple sources of products/LRUs based on a particular standard. This metric also suggests the possibility of leveraging the commercial and OEM (Original Equipment Manufacturer) support infrastructure.

Multiple Business Domains Apply/Use Standard

This metric is an extension of the previous metric, and reflects the extent to which the standard has been adopted beyond a particular market or product domain. In the event that a standard is utilized only within a particular domain, it may be a reflection of its fragility over the long haul. As an example, the ATM (Asynchronous Transfer Mode) interface standard has been adopted within the aerospace market domain, and is just as popular within the telecommunications market domain. This example might suggest additional robustness associated with the standard.

Standard Maturity

This metric suggests the longevity associated with a particular standard. A standard that is being actively revised and updated might reflect inherent scalability and continued loyalty in the marketplace.

Hardware Standards

Number of Form Factors/Number of LRUs

This measure provides insight into the number of times that a particular hardware standard is complied with across multiple LRUs (e.g., VME (Virtual Modulo Europa), CPCI (Compact Personal Computer Interface)). In this particular case, a lower number of different hardware standards or form factors is desirable.

Multiple Vendors (Greater Than 5) Exist for Products Based on Standards

This metric provides insight into the popularity of the hardware standards selected, their maturity, and whether they are still “alive”. A larger number of vendors is preferable and suggests multiple sources of products/LRUs based on a particular standard. This metric also suggests the possibility of leveraging the commercial and OEM support infrastructure.

Multiple Business Domains Apply/Use Standard

This metric is an extension of the previous metric, and reflects the extent to which the standard has been adopted beyond a particular market or product domain. In the event that a standard is utilized only within a particular domain, it may be a reflection of its fragility over the long haul. As an example, the VME standard has been adopted within the aerospace market domain, and is just as popular within other market domains such as commercial airlines, and telecommunications. This example might suggest additional robustness associated with the standard.

Standard Maturity

This metric suggests the longevity associated with a particular standard. A standard that is being actively revised and updated might reflect inherent scalability and continued loyalty in the marketplace. An example of an aging standard is VME, with the number of product offerings declining. A more vibrant alternative standard today seems to be CPCI with a larger volume of products and vendors in the market place.

Software Standards

Number of Proprietary & Unique Operating Systems

This metric assesses the total number of unique operating systems implemented with the system architecture. A lower number of proprietary and unique operating systems is most desirable.

Number of Non-Standard Databases

This metric assesses the number of non-standard databases implemented within the architecture. An effort must be made to eliminate proprietary databases, and to otherwise minimize the total number of different databases implemented within the architecture.

Number of Proprietary Middle-Ware

This metric assesses the number of non-standard middle-ware implementations within the architecture. An effort must be made to eliminate proprietary middle-ware implementations, and to otherwise minimize the total number of middle-ware implementations within the configuration.

Number of Non-Standard Languages

This metric assesses the total number of non-standard software languages used to implement software elements within the system architecture. Elimination of non-standard languages should be the goal.

Consistency Orientation

Consistency orientation is not broken further down in sub-attributes, and the ways of measuring the extent to which there are common company guidelines/standards are based on yes/no questions as listed below.

Common Guidelines for Implementing Diagnostics and PM/FL (Performance Monitoring/Fault localization)

This metric provides insight into the existence of an internal guideline with regard to the implementation of system diagnostics and PM/FL functionality within the architecture. The existence and compliance with such a guideline will facilitate commonality in the execution of this functionality across all aspects of a complex system architecture. This execution across all aspects of complex systems can have a positive impact on the associated maintenance and installation training requirements.

Common Guidelines for Implementing OMI (Operator Machine Interface)

This metric provides insight into the existence of an internal guideline with regard to the implementation of the operator-machine-interface within the architecture. The existence and compliance with such a guideline will facilitate commonality in the execution of this functionality across all aspects of a complex system architecture, along with a reduction in the number of display formats and the associated nomenclature. This commonality in turn can have a positive impact on the associated operator training and a concurrent positive impact on a reduction in operator induced failures.

RMT (Reliability, Maintainability and Testability)

This top-level attribute is obviously decomposed into three sub-attributes: reliability, maintainability, and testability. These three sub-attributes represent the most traditional and mainstream focus on system supportability. Each of these sub-attributes will be discussed in the following paragraphs, along with the related architecture evaluation metrics.

Reliability

Reliability reflects the ability of the system to operate for a length of time, under specified operational conditions, without failure. Given the focus of this analysis and evaluation, at the system architecture level versus at the component level, the concerns center around characteristics such as: redundancy and reconfigurability rather than thermal gradients on a printed circuit board. Accordingly, this sub-attribute is further decomposed into: fault tolerance and critical points of delicateness. These metrics are discussed next along with the associated metrics:

Fault Tolerance

Percentage of Mission Critical Functions With Single Points of Failure

In order to use this metric, mission critical functions need to be defined and a preliminary fault tree analysis conducted. Single points of failure might suggest an unacceptable risk associated with mission critical functions. It is desirable that such risks be eliminated from a system architecture.

Percentage of Safety Critical Functions With Single Points of Failure

The description and rationale for this metric is the same as the description and rationale for the metric immediately above.

Critical Points of Delicateness (System Loading)

Percent Processor Loading

This metric reflects the extent to which a system architecture is stressed while satisfying the necessary and required functionality. A desired characteristic of a good architecture is to feature significant potential for further growth since stressing often has a non-linear relationship to architectural “delicateness” or its ability to handle variances in the functional requirements, potential upgrades, and requirements creep.

Percent Memory Loading

The discussion and rationale for this metricis the same as the discussion and rationale for the percent processor loading metric.

Percent Network Loading

The discussion and rationale for this metric is the same as discussion and rationale for the percent processor loading metric above.

Maintainability

Maintainability reflects the ease and cost with which a failed system or system functionality can be restored. Issues with regard to task safety (equipment and personnel), number of personnel, skill level requirements, task duration, and test and support equipment requirements-standard and special, become important.

Expected Mean Time to Repair (MTTR)

Given the qualitative nature of some of the synthesis and analysis activities during the early systems engineering phase, the supportability engineer should be in a position to estimate the expected MTTR for the system architecture. This estimate would be based on a notional packaging concept, the extent of the BIT and performance monitoring/fault localization (PM/FL) functionality, and relevant experience with similar systems in the past.

Maximum Fault Group Size

In the event that the built-in-test (BIT) and PM/FL functionality has a comprehensive coverage of the system configuration, the system is expected to have a fault group size of one.

This metric reflects the ability of the architecture to isolate all failures to the faulty system elements with a high degree of confidence. In the absence of a complete system coverage, this metric reflects the ability of the architecture to isolate that source of a system failure down to a certain number of system elements. Obviously, the desire in this case is to minimize the fault group size, with one being the ideal situation.

Is System Operational During Maintenance?

It is advantageous for the system to be operational during maintenance. Such an ability can enhance the operational availability of the system architecture.

Accessibility

Are There Space Restrictions?

At an early stage in the design process, the system architectural approach adopted, and the related physical packaging concept, might indicate whether any space restrictions associated with performing maintenance exist on the system.

Are There Special Tool Requirements?

This metric is yet another key system architecture evaluation aspect. An objective in this case is to reduce, if not eliminate, the requirements for special tools and test equipment.

Are There Special Skills Requirements?

One of the objectives while developing a system is to eliminate requirements for special and unique personnel skills for maintaining the system (i.e., LRU disassembly, trouble shooting, LRU assembly). This objective is a key aspect of assessing and evaluating alternative architectures from a supportability perspective.

Testability

The ability to be tested with ease is the hallmark of a good architecture. This metric also implicitly reflects the complexity, or lack thereof, within a system architecture. Testability of a system during development, installation, and later during the operational stage is critical to its overall supportability “goodness”. Therein lies the emphasis of the metrics associated with this sub-attribute, as shown in the discussion below:

Percentage of LRUs Covered by BIT

This metric indicates the extent to which the system configuration is “covered” by the BIT functionality within the architecture. BIT functionality has a significant impact on the necessary trouble shooting involved in the event of a system failure, and the necessary maintenance skill level requirements and training.

Reproducibility of Errors

Logging/Recording Capability

This capability is a critical aspect of system testability. The ability of a system to log and record all internal “happenings” can significantly contribute to system testability and trouble shooting. It is desirable for complex and multi-functional systems to have this ability in order to contribute to system testability.

Create System State at Time of System Failure

The logic and the rationale for this metric is the same as the logic and rationale for the metric immediately above.

Online Testing

Is System Operational During External Testing?

This metric reflects the ability and the extent of the system to be tested with external tools and test equipment, without interfering with its operability in the field. Such an ability can enhance the operational availability of the system architecture.

Ease of Access to External Test Points

This metric is related to the above metric and also reflects the ease with which the system in question can be tested using external test and support equipment to supplement a built-in-test capability.

Automated Target Insertion

The functional capability of a system architecture to automate target insertion can significantly contribute to the efficiency of on-line testing, built-in-testing, and performance monitoring and fault localization. Furthermore, this ability can also be leverage to conduct on-line and embedded operation and maintenance training.

Modularity

The modularity of a system architecture is probably the most critical aspect to be considered during the synthesis of a system architecture. Modularity and interfaces are probably the most important attribute and sub-attribute, respectively, to control in order to get a good system architecture. This attribute and sub-attribute, respectively, are also to a certain degree “driving” the other attributes identified and discussed in this application. Given the strong influence and overlap of consideration between system modularity and system interfaces, these issues have been combined into a single top level attribute, modularity.

Accordingly, the modularity attribute is decomposed into five sub-attributes: physical modularity, functional modularity, orthogonality, abstraction and interfaces. All of which will be explained in the following paragraphs.

Physical Modularity

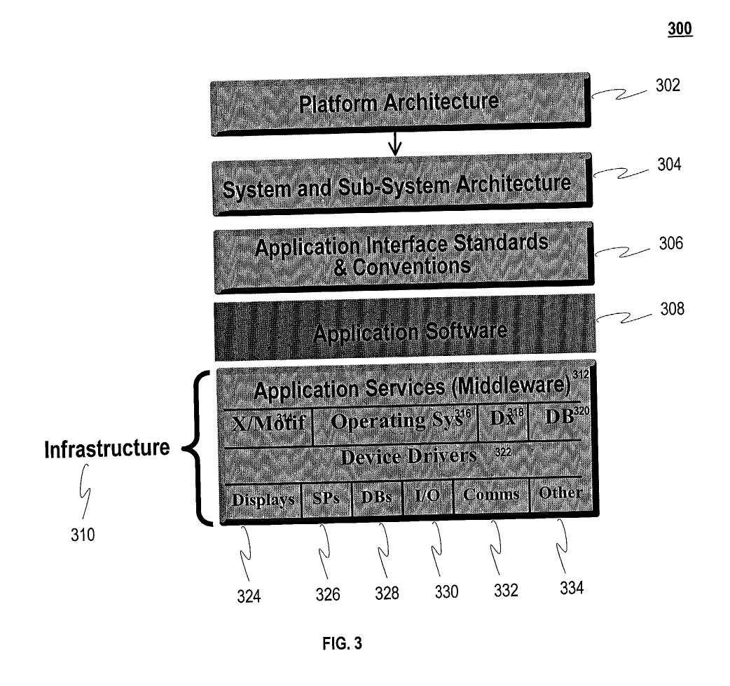

Physical modularity addresses both hardware and software issues as reflected in the following sub-attributes and associated metrics. This sub-attribute also addresses the issue of independence between the various layers of a system architecture. The ability to change one layer without impacting the rest is critical to the long term support, upgradeability, and scalability of an architecture. The concept of architectural layering is also reflected in FIG. 3.

Ease of System Element Upgrade

Lines of Modified Code

This metric reflects the ease of upgrading or refreshing a system element (hardware or software). The ripple effect of this change is reflected in terms of the amount of software that would need to be modified.

Amount of Labor Hours for System Rework

This metric has an objective similar to the one before and reflects the ease of upgrading or refreshing a system element (hardware or software). Over and above any software changes that would need to be implemented as a result of an upgrade, the change might also involve hardware repackaging and system testing.

Ease of Operating System Upgrade

Specific attention is focused on the upgrade or refresh of an operating system, given its pervasive “presence” within a system architecture. The intent of this metric is the same as that of above, and the associated metrics are also the same as above, but with a specific focus on the operating system component of the architecture.

Lines of Modified Code

This metric reflects the ease of upgrading or refreshing the operating system. The ripple effect of this change is reflected in terms of the amount of software that would need to be modified.

Amount of Labor Hours for System Rework

This metric has an objective similar to the lines of modified code metric immediately above and reflects the ease of upgrading or refreshing the operating system. Over and above any software changes that would need to be implemented as a result of an upgrade, the change might also involve hardware repackaging and system testing.

Functional Modularity

Functional modularity relates to the ease of adding new functionality as well as upgrading the existing functionality. This sub-attribute also reflects the scalability within a proposed system architecture, and the ease with which additional capability can be addressed by the architecture. As such, the associated metrics are very similar to the physical modularity attribute.

Ease of Adding New Functionality

Lines of Modified Code

This metric reflects the ease of adding additional functionality or capability to a system. The ripple effect of this change is reflected in terms of the amount of software that would need to be modified, over and above the new software being added to the system configuration.

Amount of Labor Hours for System Rework

This metric has an objective similar to the lines of modified code metric immediately above and reflects the ease of adding additional capability to a system. Over and above any software changes that would need to be implemented as a result of such an addition, the change might also involve hardware repackaging and system testing.

Ease of Upgrade Existing Functionality

Lines of Modified Code

This metric reflects the ease of upgrading existing functionality or capability within a system. The ripple effect of this change is reflected in terms of the amount of software that would need to be modified, over and above the new software being added to the system configuration.

Amount of Labor Hours for System Rework

This metric has an objective similar to the one before and reflects the ease of upgrading the capability of a system. Over and above any software changes that would need to be implemented as a result of such an upgrade, the change might also involve hardware repackaging and system testing.

Orthogonality

Orthogonality describes the extent to which there is overlapping functionality between system elements. This sub-attribute is also a reflection of the inherent complexity within a system architecture. Increased fragmentation of system functionality across multiple system elements would complicate issues pertaining to system trouble shooting, failure diagnosis, PM/FL, and the ability to upgrade or enhance system functionality. The metrics for this sub-attribute are questions as follows:

Are functional requirements fragmented across multiple processing elements and interfaces?

Are there throughput requirements across interfaces?

Are common specifications identified?

Abstraction

Given the different perspectives involved in installing a system, using a system, maintaining a system, upgrading a system, supporting a system; different stakeholders might have varying requirements with regard to the amount of detail they need to successfully execute their mission. A good architecture has the ability to provide different levels of detail to the different communities interfacing with the system. Unnecessary detail should be hidden when not required, and made accessible when the situation or task demands that. This sub-attribute is assessed with the single question below: Does the System Architecture Provide an Option for information hiding?

Interfaces

Interfaces represent yet another aspect of a system architecture that must be assessed and evaluation as part of its overall “goodness”. Management of the interfaces of a system is a key role of a system integrator. The following metrics reflect the extent to which an architecture features simplicity in its interfaces.

Number of Unique Interfaces per System Element

A good architecture will minimize the number of unique interfaces per system element. A larger number of such interfaces reflects additional complexity associated with that aspect of the system architecture.

Number of Different Networking Protocols

This metric reflects the total number of networking protocols implemented within a system architecture. For example, ATM, Ethernet, FDDI (Fiber Data Distribution Interface), and Fiber Channel Standard. A larger number of protocols will not only reflect additional complexity, but will also increase requirements pertaining to training, trouble shooting, and so on.

Does the Architecture Involve Implicit Interfaces?

Over and above the existence of explicit and “announced” interfaces, some architectures (for example, the shared memory architectures) might feature implicit architectures that have the potential of posing long term system maintenance challenges. An objective of the architecture synthesis activity might be to minimize the total number of implicit interfaces.

Number of Cables in the System

The number of cables metric is yet another reflection of the modularity within a system architecture, and the extent to which interfaces were considered in the overall system packaging approach.

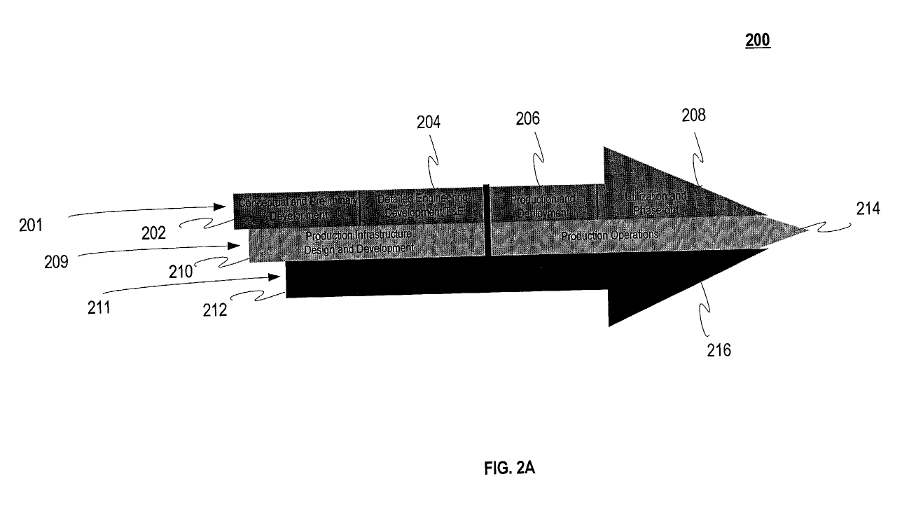

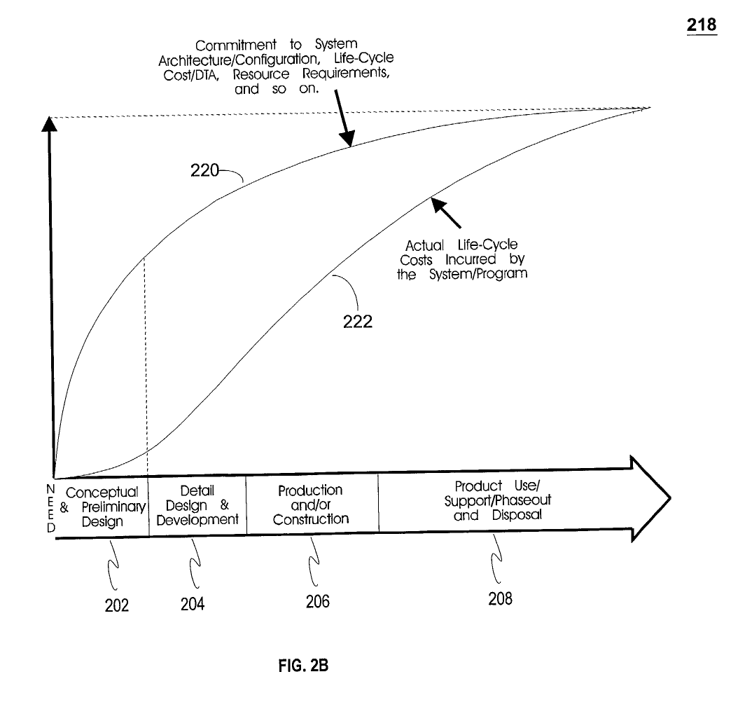

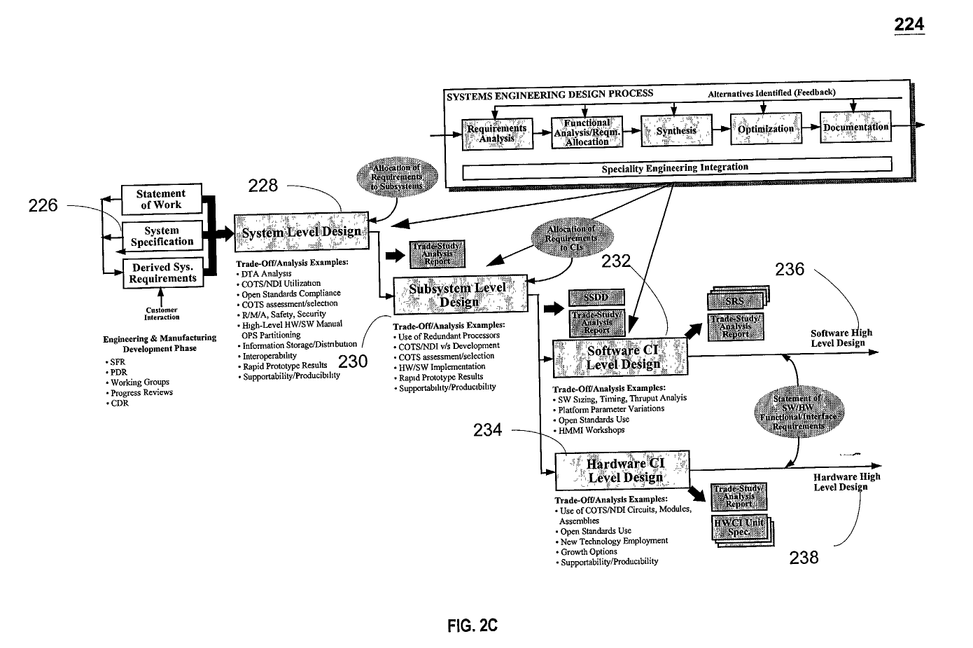

FIG. 2A depicts a block diagram 200 of an exemplary embodiment of a systems engineering process according to the present invention. FIG. 2A illustrates three concurrent lifecycles, each beginning with phases 202, 210 and 212, respectively.

The first lifecycle 201 of the three concurrent life cycles which tracks design and development of the primary product begins with phase 202. Phase 202 includes conceptual and preliminary development. From phase 202, the first lifecycle continues with phase 204 including detailed engineering and development. From phase 204, the first lifecycle continues with production and deployment. From phase 206, the first lifecycle continues with utilization and phase-out.

The second of the three concurrent life cycles 209 pertains to the preparation of a manufacturing facility. The second lifecycle begins with phase 210 which includes production infrastructure design and development, and ends with phase 214 which covers production operations.

The third of the three concurrent lifecycles 211 pertains to deployment of a maintenance and support operations capability for the deployed product of the first life cycle and the manufacturing facility of the second lifecycle. The third lifecycle begins with phase 212 which includes design and development of support infrastructure, and ends with phase 216 which includes maintenance and support operations capability.

FIG. 2B depicts an exemplary embodiment of a chart graphing actual life cycle costs incurred by a system or program on a vertical access over an entire design development, integration and maintenance of the systems engineering process life cycle. The life cycle is shown running from phase 202-208. FIG. 2B also graphs commitment to system architecture and configuration, life-cycle cost and design to affordability (DTA), and resource requirements over the systems engineering life cycle.

Phase 1 of the system life cycle begins with the identification of a functional need or operational deficiency. More often than not, a system operational deficiency can be articulated in terms of the cost of system ownership, rather than any particular prime mission performance parameter or attribute.

The operational deficiency can be translated into a system level requirements definition process through the use of tools such as quality function deployment and input-output matrices.

The requirements definition process can then be followed by the conceptual design phase involving the synthesis and selection of system-level conceptual solutions.

The preliminary design phase can involve the modeling of expected system behavior, the allocation of system level requirements to conceptual sub-systems, and the subsequent translation of the requirements into detailed design specifications. The system architecture, see description below with reference to FIG. 3, depicting the functional, operational, and physical packaging of the selected approach of the system concept can also be developed during preliminary design.

Phase 204 can include the preparation of a detailed design and development.

Phase 206 can include actual production and/or construction of the product or structure.

In phase 208, the product or structure is then deployed, installed, operated, and maintained. At the end of this operational (design) or economic life, the entity is either re-engineered to satisfy an evolving need or requirement, or properly retired or recycled.

FIG. 2C depicts an exemplary embodiment of a more detailed example of a systems engineering process of FIGS. 2A and 2B. For example, FIG. 2C could represent a more detailed version of phases 202 and/or 204. The detailed systems engineering process begins with a system specification and can proceed through a system level design process, then on to a subsystem level design process, and then on to a software and hardware system design process, yielding a software high level design and hardware high level design. If used as a preliminary design, a similar process can be performed.

FIG. 3 depicts a block diagram illustrating an exemplary embodiment of a modular layed system architecture according to the present invention. A layered system architecture provides advantages of physical and functional modularity which are both useful supportability features. FIG. 3 includes platform architecture 302, which drives as system and sub-system architecture 304. FIG. 3 further illustrates how a modular layered system design architecture can include adoption of an application interface standards and conventions 306-based solution providing further supportability features. The next layer is the application software layer representing the application software that runs on infrastructure 310. Infrastructure 310 is shown including at a base hardware level displays, system processors (SPs), databases (DBs), input output (I/O) subsystems, communications (Comms) subsystems, and any of various other subsystems 332. Above the hardware infrastructure can include any of various operating system (OS) layers 316 and firmware also referred to as device drivers 322 which can allow OS application functions to control, access and interface to hardware infrastructure 324-334. Other OS-like functions that can interface the infrastructural firmware can include, e.g., X/Motif 314—a standards-based display interface, a Dx 318 subsystem, and a database (DB) 320 storage subsystem application. Additionally, application services also referred to as middleware 312 can be provided to interface from the application software layer 308 and the various OS-like applications 314-320.

FIG. 4 depicts an exemplary embodiment of a hierarchy of a goal and exemplary multiple levels of attributes and sub-attributes according to the present invention.

The Analytic Hierarchy Process (AHP) is a theory of measurement predominantly used as a decision tool for dealing with quantifiable and/or unquantifiable (i.e., tangible or intangible criteria). AHP which was first developed by Thomas Saaty in 1980, has reported applications in numerous fields, such as economic/management problems, political problems, social problems, and technological problems. AHP enables the comparison of tangible criteria along with intangible criteria (e.g., Life-Cycle Cost would be tangible/quantifiable whereas Quality would be somewhat intangible/unquantifiable) through normalisation and the use of unit-less ratios (i.e., by dividing the Life-Cycle Cost for alternative A by the Life-Cycle Cost for alternative B, the pounds would cancel out leaving a unit-less ratio that can be compared to other unit-less ratios). In addition, AHP forces a problem to be broken into its constituent parts, which allows the problem to be solved by applying simple pair-wise comparison judgements. Finally, AHP is attractive to users because it includes a consistency checking mechanism for the pair-wise comparisons. The following discussion will provide a detailed orientation of the AHP theory including pair-wise comparisons, consistency ratios, and priority weights.

Selected commercial software packages are available which implement the AHP method. The package developed by Thomas Saaty, Expert Choice®, is a generic decision problem software package.

AHP consists of three phases: (a) synthesis of the relevant parameter hierarchy, (b) its analysis, and (c) evaluation. In designing the hierarchy, level I (i.e., top level; also called the Focus) of the hierarchy represents the overall objective of the decision, followed by subsequent levels consisting of attributes and sub-attributes (see FIG. 4). The attributes of each level must be of same magnitude since they are compared with one another at the next higher level. For example, Reliability, Maintainability, and Supportability are subsets of Availability, therefore, they cannot be on the same level as Availability, but can be on the next lower level. FIG. 4 shows the typical form of the hierarchy of AHP. The number of levels used in the hierarchy must be chosen to effectively represent the overall objective. In addition, each attribute should be limited to between 5 and 9 sub-attributes to remain effective; enough to describe the level in adequate detail, but without excessive complexity. The design of hierarchies can be an iterative process and must be done with care.

FIG. 5 depicts an exemplary embodiment of a design for supportability and upgradeability analytical hierarchy according to the present invention.

Hierarchy design is unique to each individual designer. Thus, AHP requires experience and knowledge of the problem area. A group of people may design the hierarchy by reaching consensus. FIG. 5 illustrates an example of a hierarchy design for a sample decision problem in which the objective of the decision is to determine which commercial off-the-shelf (COTS) alternative is to be procured for a project.

The analysis phase of AHP begins with pair-wise comparisons. The attributes in each level of the hierarchy are compared with one another in relative terms as to their importance/contribution to the criterion that occupies the level immediately above the attributes being compared. For example, a decision maker responds to a question that compares two attributes a and b in terms of importance or preference: “With respect to [overall objective], how much more important/preferred is [attribute a] than [attribute b].”

The choices of answers to the above question are listed in Table 1. In addition, the answers are “converted” into a numerical equivalent ranging from 1 to 9 (and their reciprocals). However, if it turns out that attribute a is less important/preferred than attribute b (as opposed to more important/preferred), then the numerical numbers would be the reciprocals, i.e., x would be 1/x. When all pair-wise comparisons for Level II are completed, the result is a matrix of pair-wise comparisons (note that if a has been compared to b, then the comparison if b to a is merely the reciprocal; also the comparison of a to a is always 1).

Table 2 illustrates an example matrix of the pair-wise comparisons for the COTS decision example shown in FIG. 5. For example, in Table 2, Life-Cycle Cost (A) is equally important as Degree of Compliance (B) and strongly more important than Installation & Maint. Services (D). Subsequent to the pair-wise comparisons, a relative scale of measurement of the priorities or weights of the attributes can be calculated using the principal right eigenvector method. These relative weights, which are normalised to one, are calculated for all attributes in the hierarchy.

TABLE 1
Suggested Degrees of Preference.

| | Then the numerical | |
|---|---|---|
| | preference is | |
| If answer is | a > b | a < b |
| Equally important/preferred, | 1 | (1/1) |
| Weakly (less) more important/preferred, | 3 | (1/3) |
| Strongly more (less) important/preferred, | 5 | (1/5) |
| Very strongly more (less) important/preferred, | 7 | (1/7) |
| Absolutely more (less) important/preferred, | 9 | (1/9) |

* Note that even numbers (2, 4, 6, 8) are used to represent compromises between the above preferences.

The eigenvector of a matrix can be calculated by most matrix/math computer programs such as MatLab®, which raise the matrix to a large power until the numbers converge. After the eigenvectors are determined, they are normalised to 1 simply by dividing each value by the total sum. Saaty has developed an approximation method for calculating the eigenvectors of a matrix, but with the aid of computers, this is unnecessary (for more information regarding this approximation method, see (Canada, et al, pending)). Note that the normalised eigenvectors have been calculated in Table 2.

TABLE 2
Matrix of Paired Comparisons for Level II.

| With Respect to the “Best COTS | | | | | Normalised |
|---|---|---|---|---|---|
| Alternative” | A | B | C | D | Eigenvectors |
| A. Life-Cycle Cost | 1 | 1 | 3 | 5 | 0.390 |
| B. Degree of Compliance | 1 | 1 | 3 | 5 | 0.390 |
| C. Availability | ⅓ | ⅓ | 1 | 3 | 0.152 |
| D. Inst. & Maint. Services | ⅕ | ⅕ | ⅓ | 1 | 0.068 |

The next step is to perform a consistency check to ensure validity for the suggested degrees of preference of the attributes. The consistency ratio (CR) is an approximate indicator of the consistency of the pair-wise comparisons. It is based on the deviation from the perfect cardinal consistency (i.e., if attribute X is 3 times more important than attribute Y, and alternative Y is 3 times more important than alternative Z, then alternative X should be 9 times more important than alternative Z; the C.R. is based on the deviation of the pair-wise comparisons from these relationships). Saaty suggests that if the CR is less than or equal to 0.10, then the consistency is generally acceptable. However, if the CR is greater than 0.10, the pair-wise comparisons should be rechecked.

To compute the CR, the matrix of pair-wise comparisons (i.e., the matrix in Table 2) must be multiplied with the principle vector of priority weights (i.e., the normalised eigenvectors in Table 2). This procedure is shown below using the values from Table 2. Note the resulting vector is labelled “[C]”.

$${[ \begin{matrix}1 & 1 & 3 & 5 \\ 1 & 1 & 3 & 5 \\ 1 / 3 & 1 / 3 & 1 & 3 \\ 1 / 5 & 1 / 5 & 1 / 3 & 1\end{matrix} ]}^{[ A ]} \cdot {[ \begin{matrix}0.390 \\ 0.390 \\ 0.152 \\ 0.068\end{matrix} ]}^{[ B ]} = {[ \begin{matrix}1.576 \\ 1.576 \\ 0.616 \\ 0.275\end{matrix} ]}^{[ C ]}$$

The next step is to divide the elements in vector [C] by the corresponding elements in vector [B]. The result is vector [D], whose average is the approximate maximum eigenvalue, λₘₐₓ. λₘₐₓ is used to calculate the consistency index (CI). See below for the sample calculations, using the vectors from the previous sample calculations:

$$\begin{matrix}[ D ] = \vert 1.576 / 0.39 , 1.576 / 0.39 , 0.616 / 0.152 , 0.275 / 0.068 \vert \\ = \vert 4.04 , 4.04 , 4.05 , 4.04 \vert \\ {λ}_{max} = [ 4.04 + 4.04 + 4.05 + 4.04 ] / 4 = 4.04\end{matrix}$$

The consistency index (CI) of a matrix of rank N is

CI=(λₘₐₓ−N)/(N−1)

For the example, the CI is

CI=(4.04−4)/(4−1)=0.01

Finally, the CI is compared (via ratio) to the random index (RI), which is based on values that would have been obtained had the pair-wise comparison matrix been filled “randomly” (i.e., placing numbers from 1 to 9 and their reciprocals in the pair-wise comparison matrix randomly without using any judgement). Saaty has calculated the RI (given in Table 3), which were obtained from large numbers of simulation runs on a computer. Note that a matrix of rank N=4 has an RI of 0.90.

TABLE 3
The Random Indexes for Various Matrices of Rank N*.

| N | 1 | 2 | 3 | 4 | 5 | 6 | 7 | 8 | 9 | ... |
|---|---|---|---|---|---|---|---|---|---|---|
| RI | 0.00 | 0.00 | 0.58 | 0.90 | 1.12 | 1.24 | 1.32 | 1.41 | 1.45 | ... |

*Source: Canada, et al, pending

Using the values from the sample calculations above, the calculation of the consistency ratio (CR) is shown below. Note again that in this example, the rank of matrix in Table 2 is 4 with a corresponding RI of 0.9.

CR−CI/RI=0.01/0.9=0.01

Note: Since the CR<0.10, the pair-wise comparisons are reasonably consistent. The AHP process may continue. If the CR had been >0.10, then the pair-wise comparisons would have been rechecked. It is possible to develop an expert system to determine where the inconsistencies are located. However, Expert Choice® do not have this capability.

If there are levels below Level II (recall that Level I is the overall objective of the decision) consisting of sub-attributes such as in the example shown by FIGS. 4 and 5, the sub-attributes also must be compared pair-wise with respect to their parent attribute (as well as the consistency check). For example, under the attribute Life-Cycle Cost, the four sub-attributes (i.e., Acquisition Cost, Operations & Maintenance Cost, Installation & Training Cost, and Technical Support Cost) must be compared with one another with respect to Life-Cycle Cost. Table 4 summarizes the matrix. In this example, the pair-wise comparison matrix contains the same numbers as in Table 2. Thus, the eigenvectors are the same as well as the CR.

When all sub-attributes have been compared pair-wise, the alternatives must be compared pair-wise with respect to the sub-attributes. For example, with respect to Acquisition Cost, Alternative A must be compared with Alternative B, and so on. The unique feature of these sets of pair-wise comparisons is that the alternatives may be compared using subjective judgements (as previously done with the 1 to 9 scale) or compared using performance data (when available). For example, as shown in Table 5, the Acquisition Cost (dollars) or the Internal Compliance (number or percentage of requirements satisfied) may be available or estimable. In this case, it is desirable to perform the pair-wise comparisons using the performance data since it is objective. However, the performance data must have a linear relationship for this method to work, i.e., $100 is twice as good (or bad) as $50.

TABLE 4
Matrix of Pair-wise Comparisons for the Sub-attributes of Life-Cycle Cost

| | | | | | Normalised |
|---|---|---|---|---|---|
| With Respect to the “Life-Cycle Cost” | A | B | C | D | Eigenvectors |
| A. Acquisition Cost | 1 | 1 | 3 | 5 | 0.390 |
| B. Operations & Maint Cost | 1 | 1 | 3 | 5 | 0.390 |
| C. Installation & Training Cost | 1/3 | 1/3 | 1 | 3 | 0.152 |
| D. Technical Support Cost | 1/5 | 1/5 | 1/3 | 1 | 0.068 |

TABLE 5
Performance Data for Selected Alternatives

| | | | | | Is higher |
|---|---|---|---|---|---|
| Attribute | Units | Alt A | Alt B | Alt C | better? |
| Internal Compliance | Req'ts Satisfied | 1350 | 1000 | 1500 | Yes |
| Acquisition Cost | Dollars | $3 M | $5 M | $3.5 M | No |

Referring to Table 5, note that Internal Compliance is better with higher values (i.e., 1500 requirements satisfied is better than 1000 requirements satisfied; therefore Alternative C is better than Alternative B with respect to Internal Compliance). Conversely, Acquisition Cost is better with lower numbers (e.g., a cost of $3.5 million is better than a cost of $5 million; therefore Alternative C is better than Alternative B with respect to Acquisition Cost). In the case that higher is better, the numbers are simply normalised to 1 as shown below using the Internal Compliance data from Table 5:

| | |
|---|---|
| Alt A | 1350/(1350 + 1000 + 1500) = 0.35 |
| Alt B | 1000/(1350 + 1000 + 1500) = 0.26 |
| Alt C | 1500/(1350 + 1000 + 1500) = 0.39 |
| | Σ = 1.00 |

In the case that lower is better, the minimum value (i.e., “best”) is divided by each performance value. Then, the numbers are normalised to one as shown below using the Acquisition Cost data from Table 5:

| | Ratio | Normalized |
|---|---|---|
| Alt A | $3M/$3M = 1.000 | 0.41 |
| Alt B | S3M/$5M = 0.600 | 0.24 |
| Alt C | $3M/$3.5M = 0.857 | 0.35 |
| | | Σ = 1.00 |

Table 6 provides an example summary of all the calculated eigenvectors (also called priority weights) for the hierarchy design illustrated in Figure A.2 that would have been calculated up to this point. The top row of numbers, labelled “Attribute Weights”, were the numbers calculated in Table 2. The next row of numbers, labelled “Sub-attribute Weights”, were calculated for Life-Cycle Cost in Table 4. Finally, the next three rows of numbers, labelled “Alt A (Level IV) Weights”, “Alt B (Level IV) Weights”, and “Alt C (Level IV) Weights”, were calculated by using the pair-wise comparison method for subjective data or by using the performance data method described by using the data in Table 5.

The global priority weight (GPW) is the overall priority weight (or eigenvector) of the alternatives, which sum to 1. To determine the global priority weights (GPW) of the alternatives, compute the sum of the product of weights for all branches that include the alternative. For example, using Table .5, the GPW for Alternative A is shown below:

GPW(A)=(0.39)[(0.390)(0.407)+(0.390)(0.319)+(0.152)(0.231)+(0.068)(0.400)]+(0.39)[(0.056)(0.188)+(0.650)(0.351)+(0.147)(0.178)+(0.147)(0.243)]+(0.152)[(0.333)(0.143)+(0.333)(0.258)+(0.333)(0.105)]+(0.068)[(0.522)(0.785)÷(0.078)(0.429)÷(0.200)(0.731)+(0.200)(0.655)]=0.327

Similarly, the GPW for Alternatives B and C are 0.253 and 0.422, respectively. Since the GPW for C is the highest (i.e., best), Alternative C is the recommended alternative to choose, given the inputs.

AHP has proven to be an effective tool for making multi-criteria decisions. It is relatively simple to use; it breaks down a problem into smaller, more managable components by designing a hierarchy; it provides an effective means in quantifying intangible criteria; and it includes a consistency checking mechanism. However, there are several criticisms of using AHP. First, since the method deals with intangible data, the judgements of relative importance should be performed by experts. Also, care must be taken not to violate the axioms of AHP (listed below) when designing the hierarchy. An example of a problem with AHP caused by violating axioms b 3 and 4 is known as rank reversal, which is the reversing of rankings when a new alternative is introduced. Below are the axioms of AHP:

Axiom 1: (Reciprocal Comparison). The decision maker must be able to make comparisons and state the strength of his preferences. The intensity of these preferences must satisfy the reciprocal condition: If A is x times more preferred than B, then B is 1/x times more preferred than A.

Axiom 2: (Homogeneity). The preference are represented by means of a bounded scale.

Axiom 3: (Independence). When expressing preferences, criteria are assumed independent of the properties of the alternatives.

Axiom 4: (Expectations). For the purpose of making a decision, the hierarchic structure is assumed to be complete.

As stated in the introduction, AHP has found uses in a wide range of decision problems. In addition, since descriptions and judgements are linguistic and qualitative, new research is being done with AHP by applying fuzzy logic. Finally, many researchers are looking at combining AHP with other tools to create more robust tools. For example, the use of AHP to prioritise customer requirements for use in QFD is being studied.

TABLE 6
Summary of all Priority Weights for the COTS Example.

| | Life-Cycle | | | | | | | | Availa- | | |
|---|---|---|---|---|---|---|---|---|---|---|---|
| | Cost | | | | Compliance | | | | bility | | |
| Attribute | 0.39 | | | | 0.39 | | | | 0.152 | | |
| Weights | | | | | | | | | | | |
| Sub- | Acq | O & M | Inst & | Tech | Prod | Internal | Industry | ISO | Reli- | Maintain- | Support- |
| attributes | Cost | Cost | Trng | Support | Stds | Compli- | Stds | 9000 | ability | ability | ability |
| | | | Cost | Cost | | ance | | | | | |
| Sub- | .390 | .390 | .152 | .068 | .056 | .650 | .147 | .147 | .333 | 333 | .333 |
| attribute | | | | | | | | | | | |
| Weights | | | | | | | | | | | |
| Alt A | .407 | .319 | .231 | .400 | .188 | .351 | .178 | 243 | .143 | .258 | .105 |
| (Level IV) | | | | | | | | | | | |
| Weights | | | | | | | | | | | |
| Alt B | .244 | .255 | .462 | 300 | .081 | .260 | .070 | .088 | .429 | .105 | .637 |
| (Level IV) | | | | | | | | | | | |
| Weights | | | | | | | | | | | |
| Alt C | .349 | .426 | .308 | .300 | .731 | .390 | .751 | .669 | .429 | .637 | .258 |
| (Level IV) | | | | | | | | | | | |
| Weights | | | | | | | | | | | |

| | Installation & Maintenance | | | | |
|---|---|---|---|---|---|
| | Services | | | | GPW |
| Attribute | 0.068 | | | | N/A |
| Weights | | | | | |
| Sub- | Response | Maint | Special | Packaging | N/A |
| attributes | Time | Org. | Support | & | |
| | | | | Handling | |
| Sub- | .522 | .078 | .200 | .200 | N/A |
| attribute | | | | | |
| Weights | | | | | |
| Alt A | .785 | .429 | .731 | .655 | .327 |
| (Level IV) | | | | | |
| Weights | | | | | |
| Alt B | .066 | .143 | .081 | .055 | .253 |
| (Level IV) | | | | | |
| Weights | | | | | |
| Alt C | .149 | .429 | .188 | .290 | .422 |
| (Level IV) | | | | | |
| Weights | | | | | |

Exemplary Implementation of the Evaluation Framework

This sub-section describes an exemplary implementation embodiment including brief descriptions of exemplary graphical user interface (GUI) views of an exemplary decision support system. The decision support system depicted is from Expert Choice™ model available from Expert Choice, Inc. of Pittsburgh, Pa., U.S.A., to briefly illustrate what the attribute hierarchy looks like when implemented within this SW. The name of the tool is a supportability evaluation of system architectures (SEA). The attribute hierarchy represented in the screenshots is equivalent to the attribute hierarchy shown in FIG. 1.

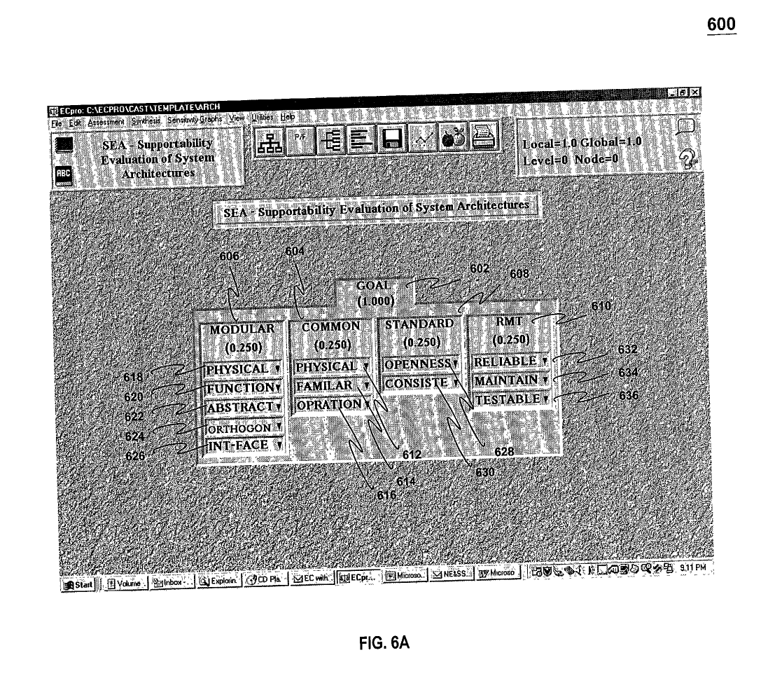

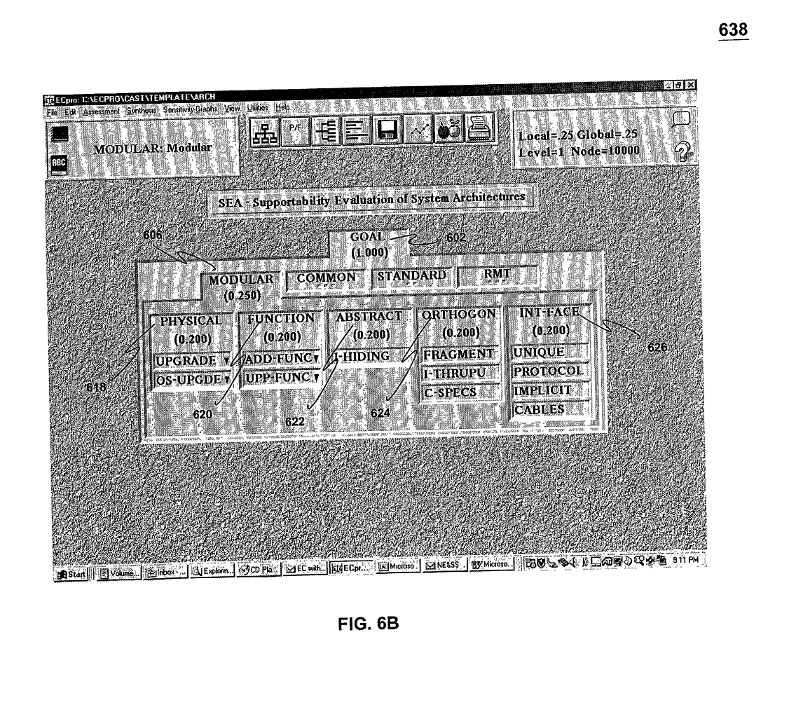

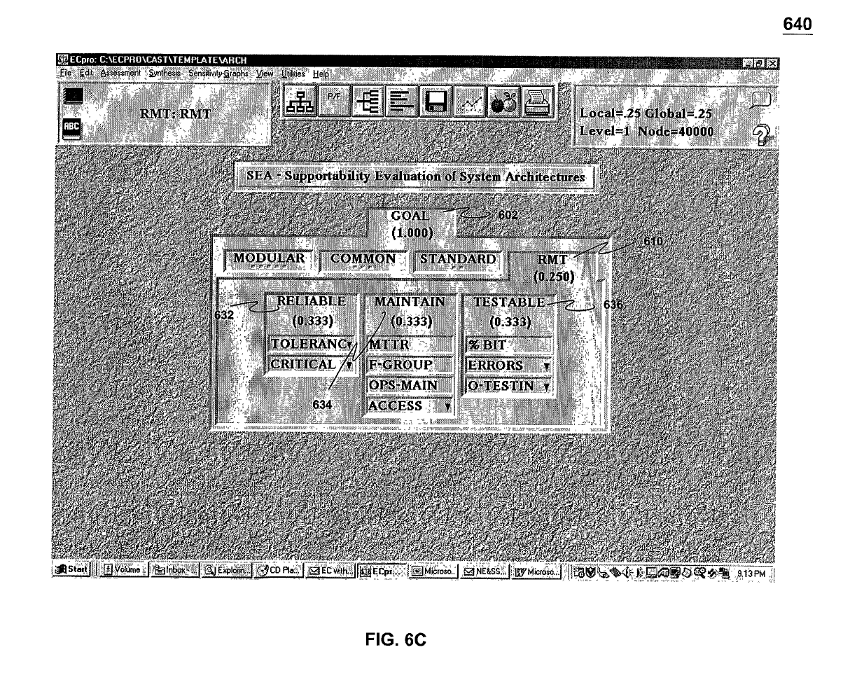

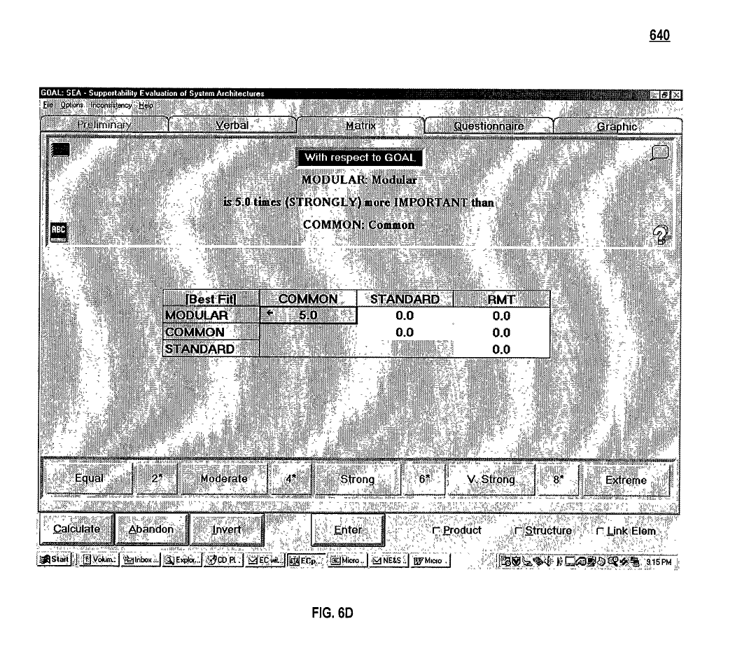

FIG. 6A depicts an exemplary embodiment of a graphical user interface (GUI) of an exemplary implementation embodiment of a supportability evaluation of system architectures decision support system with illustrative attributes and sub-attributes according to the present invention.

FIG. 6A depicts an exemplary embodiment of a GUI showing a high level attribute hierarchy. FIG. 6A shows the four top-level attributes; Modularity, Commonality, Standards Based and RMT (Reliability, Maintainability and Testability) and their sub-attributes. Depending on the objective and scope of the evaluation, the attributes and metrics can be weighted subjectively. The default values are assigned by dividing the total by the number of attributes at the same level, for example illustrated with 0.25 across the four main attributes in FIG. 6A.

FIG. 6B depicts an exemplary embodiment a GUI of an exemplary implementation embodiment of a supportability evaluation of system architectures decision support system with a selected modular attribute and depicting sub-attributes of the modular attribute and nested additional sub-attributes of the sub-attributes according to the present invention.

FIG. 6B depicts an exemplary embodiment of a GUI representing SEA-Modularity Sub-Attributes.

FIGS. 6B and 6C illustrate the further breakdown of two of the main attributes;

Modularity and RMT, respectively. Modularity, for example, has 5 sub-attributes and these further have metrics associated with them. Some of these metrics also are broken down further as illustrated with the red triangles.

FIG. 6C depicts an exemplary embodiment a GUI of an exemplary implementation embodiment of a supportability evaluation of system architectures decision support system with a selected reliability, maintainability and testability (RMT) attribute and depicting sub-attributes of the RMT attribute and nested additional sub-attributes of the sub-attributes according to the present invention.

FIG. 6D illustrates the tool's capability to make pair-wise comparisons based on customer (subjective) priorities for the specific domain in question. This was discussed in Appendix A. The exemplary GUI illustrates the particular case where modularity is said to be 5 times more important than commonality. The ability to make pair-wise comparisons and assign priorities is applicable at all levels in the hierarchy—for attributes as well as metrics.

In many ways the attribute hierarchy developed represents a first attempt in creating an evaluation framework for architectures from a supportability point of view. The hierarchy shown in FIG. 1 is an exemplary hierarchy, it will be apparent to those skilled in the relevant art that there are many ways in which this attribute hierarchy could be improved in order to enhance the understanding of the attribute hierarchy itself and the exemplary SW model. The AHP of the present invention can also be customized for specific domains.

The attribute hierarchy shown in FIG. 1 is developed to be a domain independent. Making the attribute hierarchy domain dependent is one extension, and this possibility together with other extensions of this research is discussed below.

Making the Attribute Hierarchy Domain and Customer Dependent

In order to apply the evaluation framework described herein to a particular domain or customer, the system evaluator may need to tailor the attributes and sub-attributes identified so far, as well as assess and adapt their priorities. The attributes will need to represent the evaluation perspective (user and operator perspective; system integrator perspective; maintainer perspective; purchaser perspective).

While the attribute hierarchy has been developed by studying literature and interviewing people that are related to military industry, and as such might be domain dependent in that respect, it could for example be extended to become more applicable to other business domains such as medical and telecommunications, and other commercial areas. Further, within the hierarchy it is possible to make it domain dependent with regard to how applicable it is with regard to different systems, for example a missile, a tank, a combat system or a frigate. A tailored attribute hierarchy for evaluating a missile system would look quite different from an attribute hierarchy for a combat system. Also the tailoring process might make it necessary to add attributes and ways of measuring these to make it domain specific.

Including domain specific metrics (define nominal values) for the quantitative metrics is another way of making the attribute hierarchy domain specific. The number of LRU's for a missile system will differ quite significantly from a submarine for example when it comes to what is a “good” number of LRU's. By changing the system view, it could be possible to also make the attribute hierarchy domain specific with regard to different system levels.

Having discussed domain dependence, an evaluation will also to a certain degree be customer specific. Tailoring in this respect can for example be done by assigning customer specific priorities for the attributes.

Adding Cost in the Attribute Hierarchy

Cost could also be included in another exemplary embodiment. Cost has been left out of the scope of the exemplary embodiment due to the complexity involved.

1. At which level should costs be considered? At the top level, main attribute level or for each sub-attributes and the associated metrics? The easiest way, but also the most time consuming way, may be to look at the metrics for each sub-attribute and calculate the consequences in terms of costs for the different answers where possible. For example, looking at the “Modularity” attribute where metrics are in terms of labor hours. This can easily be translated into costs, but this of course will be domain dependent as labor hours may differ significantly. For another attribute, “Standards Based”, it might be difficult and time consuming to calculate the costs of having to implement four interface standards relative to two.

2. Which attributes are not possible to quantify from a cost point of view? And which are easy to measure in terms of costs?

3. Should “absolute” or relative cost differences be highlighted? Since uncertainty is high in the early phases of a system design, relative cost comparisons should probably get the main focus.

4. Can a “cost template” be created in order to help get an idea of the relative cost differences for systems being evaluated? Going back to the example mentioned above for interface standards implemented, it should be possible to come up with some average/general number of costs for implementing a standard taking certain assumptions into consideration. The same approach can be used for many of the sub-attributes/metrics in the hierarchy as well, to end up with some kind of “cost template”.

5. The purpose of adding costs as discussed above has had an implicit assumption of making trade-off analyses for “costs versus costs” for different systems. Another aspect that should be considered is the possibility of making trade-off study's for “costs versus technology”.

Clearly cost as an attribute itself would become very domain and customer specific. However, in order for the hierarchy to be applicable to for example commercial industry, cost becomes a critical issue. As always the purpose of the evaluation will have to decide to which extent cost need to be considered.

While various embodiments of the present invention have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

What is claimed is:

1. A decision support system for evaluating supportability of alternative system architecture designs comprising:
an analytic hierarchy process (AHP) model comprising a plurality of attributes, wherein said plurality of attributes comprises:
a commonality attribute;
a modularity sub-attribute;
a standards based sub-attribute; and
a reliability, maintainability, testability (RMT) sub-attribute.

2. The system of claim 1, wherein said commonality attribute comprises:
a plurality of sub-attributes of said commonality attribute, said plurality of sub-attributes of said commonality attribute comprising at least one of:
a physical commonality sub-attribute;
a physical familiarity sub-attribute; and
an operational commonality sub-attribute.

3. The system of claim 2, wherein said physical commonality sub-attribute further comprises:
a plurality of sub-attributes of said physical commonality sub-attribute, said plurality of sub-attributes of said physical commonality sub-attribute comprising at least one of:
a hardware (HW) commonality sub-attribute; and
a software (SW) commonality sub-attribute.

4. The system of claim 3, wherein said hardware commonality sub-attribute comprises:
a plurality of sub-attributes of said hardware commonality sub-attribute, said plurality of sub-attributes of said hardware commonality sub-attribute comprising at least one of:
a number of unique lowest replaceable units (LRUs) sub-attribute;
a number of unique fasteners sub-attribute;
a number of unique cables sub-attribute; and
a number of unique standards Implemented sub-attribute.

5. The system of claim 3, wherein said software commonality sub-attribute comprises:
a plurality of sub-attributes of said software commonality sub-attribute, said plurality of sub-attributes of said software commonality sub-attribute comprising at least one of:
a number of unique SW packages implemented sub-attribute;
a number of languages sub-attribute;
a number of compilers sub-attribute;
a average number of SW instantiations sub-attribute; and
a number of unique standards implemented sub-attribute.

6. The system of claim 2, wherein said physical familiarity sub-attribute comprises:
a plurality of sub-attributes of said physical familiarity sub-attribute, said plurality of sub-attributes of said physical familiarity sub-attribute comprising at least one of:
a percentage vendors known sub-attribute;
a percentage subcontractors known sub-attribute;
a percentage HW technology known sub-attribute; and
a percentage SW technology known sub-attribute.

7. The system of claim 2, wherein said operational commonality sub-attribute comprises:
a plurality of sub-attributes of said operational commonality sub-attribute, said plurality of sub-attributes of said operational commonality sub-attribute comprising at least one of:
a percentage of operational functions automated sub-attribute;
a number of unique skill codes required sub-attribute;
an estimated operational training time—initial sub-attribute;
an estimated operational training time—refresh from previous system sub-attribute;
an estimated maintenance training time—initial sub-attribute; and
an estimated maintenance training time—refresh from previous system sub-attribute.

8. The system of claim 1, wherein said modularity attribute comprises:
a plurality of sub-attributes of said modularity attribute, said plurality of sub-attributes of said modularity attribute comprising at least one of:
a physical modularity sub-attribute;
a functional modularity sub-attribute;
an orthogonality sub-attribute;
an abstraction sub-attribute; and
an interfaces sub-attribute.

9. The system of claim 8, wherein said physical modularity sub-attribute comprises:
a plurality of sub-attributes of said physical modularity sub-attribute, said plurality of sub-attributes of said physical modularity sub-attribute comprising at least one of:
an ease of system element upgrade sub-attribute; and
an ease of operating system element upgrade sub-attribute.

10. The system of claim 9, wherein said ease of system element upgrade sub-attribute comprises:
a plurality of sub-attributes of said ease of system element upgrade sub-attribute, said plurality of sub-attributes of said ease of system element upgrade sub-attribute comprising at least one of:
a lines of modified code sub-attribute; and
an amount of labor hours for system rework sub-attribute.

11. The system of claim 9, wherein said ease of operating system element upgrade sub-attribute comprises:
a plurality of sub-attributes of said ease of operating system element upgrade sub-attribute, said plurality of sub-attributes of said ease of operating system element upgrade sub-attribute comprising at least one of:
a lines of modified code sub-attribute; and
an amount of labor hours for system rework sub-attribute.

12. The system of claim 8, wherein said functional modularity sub-attribute further comprises:
a plurality of sub-attributes of said functional modularity sub-attribute, said plurality of sub-attributes of said functional modularity sub-attribute comprising at least one of:
an ease of adding new functionality sub-attribute; and
an ease of upgrade existing functionality sub-attribute.

13. The system of claim 12, wherein said ease of adding new functionality sub-attribute further comprises:
a plurality of sub-attributes of said ease of adding new functionality sub-attribute, said plurality of sub-attributes of said ease of adding new functionality sub-attribute comprising at least one of:
a lines of modified code sub-attribute; and
an amount of labor hours for system rework sub-attribute.

14. The system of claim 12, wherein said ease of upgrading existing functionality sub-attribute, said plurality of sub-attributes comprises:
a plurality of sub-attributes of said ease of upgrading existing functionality sub-attribute, said plurality of sub-attributes of said ease of upgrading existing functionality sub-attribute comprising at least one of:
a lines of modified code sub-attribute; and
an amount of labor hours for system rework sub-attribute.

15. The system of claim 8, wherein said orthogonality sub-attribute comprises:
a plurality of sub-attributes of said orthogonality sub-attribute, said plurality of sub-attributes of said orthogonality sub-attribute comprising at least one of:
a determination of whether functional requirements are fragmented across multiple processing elements and interfaces sub-attribute;
a determination of whether there are throughput requirements across interfaces sub-attribute; and
a determination of whether common specifications are identified sub-attribute.

16. The system of claim 8, wherein said abstraction sub-attribute comprises:
a plurality of sub-attributes of said abstraction sub-attribute, said plurality of sub-attributes of said abstraction sub-attribute comprising:
a determination of whether the system architecture provides an option for information hiding sub-attribute.

17. The system of claim 8, wherein said interfaces sub-attribute comprises:
a plurality of sub-attributes of said interfaces sub-attribute, said plurality of sub-attributes of said interfaces sub-attribute comprising at least one of:
a number of unique interfaces per system element sub-attribute;
a number of different networking protocols sub-attribute;
an explicit versus implicit interfaces sub-attribute;
a determination of whether the architecture involves implicit interfaces sub-attribute; and
a number of cables in the system sub-attribute.

18. The system of claim 1, wherein said AHP structure further comprises:
a plurality of sub-attributes of said standards based attribute, said plurality of sub-attributes of said standards based attribute comprising at least one of;
an open systems orientation sub-attribute; and
a consistency orientation sub-attribute.

19. The system of claim 18, wherein said open systems orientation sub-attribute comprises:
a plurality of sub-attributes of said open systems orientation sub-attribute, said plurality of sub-attributes of said open systems orientation sub-attribute comprising at least one of:
an interface standards sub-attribute;
a HW standards sub-attribute; and
a software standards sub-attribute.

20. The system of claim 19, wherein said interface standards sub-attribute comprises:
a plurality of sub-attributes of said interface standards sub-attribute, said plurality of sub-attributes of said interface standards sub-attribute comprising at least one of:
a number of interface standards/number and number of Interfaces sub-attribute;
a determination of multiple vendors (greater than 5) existing for products based on standards sub-attribute;
a multiple business domains apply/use standard (Aerospace, Medical, Telecommunications) sub-attribute; and
a standard maturity sub-attribute.

21. The system of claim 19, wherein said hardware standards sub-attribute comprises:
a plurality of sub-attributes of said hardware standards sub-attribute, said plurality of sub-attributes of said hardware standards sub-attribute comprising at least one of:
a number of form factors and number of LRUs sub-attribute;
a multiple vendors (greater than 5) exist for a products based on standards sub-attribute;
a multiple business domains apply/use standard (aerospace, medical, telecommunications) sub-attribute; and
a standard maturity sub-attribute.

22. The system of claim 19, wherein said software standards sub-attribute comprises:
a plurality of sub-attributes of said software standards sub-attribute, said plurality of sub-attributes of said software standards sub-attribute comprising at least one of:
a number of proprietary & unique operating systems sub-attribute;
a number of non-std databases sub-attribute;
a number of proprietary middle-ware sub-attribute; and
a number of non-std languages sub-attribute.

23. The system of claim 18, wherein said consistency orientation sub-attribute comprises:
a plurality of sub-attributes of said consistency orientation sub-attribute, said plurality of sub-attributes of said consistency orientation sub-attribute comprising at least one of:
common guidelines for implementing diagnostics and performance monitoring/fault localization (PM/FL) sub-attribute; and
common guidelines for implementing operator machine interface (OMI) sub-attribute.

24. The system of claim 1, wherein said RMT attribute comprises:
a plurality of sub-attributes of said RMT attribute, said plurality of sub-attributes of said RMT attribute comprising at least one of:
a reliability sub-attribute;
a maintainability sub-attribute; and
a testability sub-attribute.

25. The system of claim 24, wherein said reliability sub-attribute comprises:
a plurality of sub-attributes of said reliability sub-attribute, said plurality of sub-attributes of said reliability sub-attribute comprising at least one of:
a fault tolerance sub-attribute; and
a critical points of delicateness (system loading) sub-attribute.

26. The system of claim 25 wherein said fault tolerance sub-attribute comprises:
a plurality of sub-attributes of said fault tolerance sub-attribute, said plurality of sub-attributes of said fault tolerance sub-attribute comprising at least one of:
a percentage of mission critical functions with single points of failure sub-attribute; and
a percentage of safety critical functions with single points of failure sub-attribute.

27. The system of claim 25 wherein said critical points of delicateness (system loading) sub-attribute further comprises:
a plurality of sub-attributes of said critical points of delicateness (system loading) sub-attribute, said plurality of sub-attributes of said critical points of delicateness (system loading) sub-attribute comprising at least one of:
a percentage of processor loading sub-attribute;
a percentage of memory loading sub-attribute; and
a percentage of network loading sub-attribute.

28. The system of claim 27 wherein said percentage memory loading sub-attribute comprises a criticality assessment sub-attribute of said percentage memory loading sub-attribute.

29. The system of claim 27 wherein said percentage network loading sub-attribute comprises a criticality assessment sub-attribute of said percentage network loading sub-attribute.

30. The system of claim 24, wherein said maintainability sub-attribute comprises:
a plurality of sub-attributes of said maintainability sub-attribute, said plurality of sub-attributes of said maintainability sub-attribute comprising at least one of:
an expected MTTR sub-attribute;
a maximum fault group size sub-attribute;
a determination of whether system is operational during maintenance sub-attribute; and
an accessibility sub-attribute.

31. The system of claim 30, wherein said accessibility sub-attribute further comprises:
a plurality of sub-attributes of said accessibility sub-attribute, said plurality of sub-attributes of said accessibility sub-attribute comprising at least one of:
a space restrictions determination sub-attribute;
a special tool requirements determination sub-attribute; and
a special skill requirements determination sub-attribute.

32. The system of claim 24, wherein said testability sub-attribute comprises:
a plurality of sub-attributes of said testability sub-attribute, said plurality of sub-attributes of said testability sub-attribute comprising at least one of:
a BIT Coverage sub-attribute;
an error reproducibility sub-attribute;
an online testing sub-attribute; and
an automated input/stimulation insertion sub-attribute.

33. The system of claim 32 wherein said error reproducability sub-attribute comprises:
a plurality of sub-attributes of said error reproducability sub-attribute, said plurality of sub-attributes of said error reproducability sub-attribute comprising at least one of:
a logging/recording capability sub-attribute; and
a determination of whether system state at time of system failure can be created sub-attribute.

34. The system of claim 32 wherein said online testing sub-attribute comprises:
a plurality of sub-attributes of said online testing sub-attribute, said plurality of sub-attributes of said online testing sub-attribute comprising at least one of:
a determination of whether system is operational during external testing sub-attribute; and
an ease of access to external testpoints sub-attribute.

35. A decision support system for evaluating the supportability of alternative system architecture designs comprising:
means for assigning relative weights to each attribute and sub-attribute of a plurality of attributes and sub-attributes of an analytical hierarchy process (AHP) model wherein said plurality of attributes comprises:
a commonality attribute,
a modularity attribute,
a standards based attribute, and
a reliability, maintainability, and testability (RMT) attribute, comprising:
means for performing pair-wise comparisons of said plurality of attributes and sub-attributes at all levels of said AHP model, and
means for assigning relative weights to all of said attributes and sub-attributes at all levels of said AHP model;
means for generating a GPW for each of a plurality of alternative system architecture designs comprising:
means for performing pair-wise comparisons of each of said plurality of
alternative system architecture designs with respect to said all of said attributes
and sub-attributes at all levels of said AHP model; and
means for evaluating said plurality of alternative system architecture designs from a supportability perspective comprising comparing values of said GPWs of said plurality of alternative system architecture designs.

36. A decision support system that determines global priority weights (GPWs) of alternative system architecture designs comprising:
an analytic hierarchy process engine
operative to compare a plurality of relative priority attribute weights to generate the GPW of each of the alternative system architecture designs wherein the relative priority attribute weights correspond to a plurality of attributes; and
operative to compare a plurality of relative priority sub-attribute weights to generate each of said plurality of relative priority attribute weights wherein the relative priority sub-attribute weights correspond to a plurality of sub-attributes;
wherein said plurality of attributes comprises
a commonality attribute;
a modularity attribute;
a standards based attribute; and
a reliability, maintainability, and testability (RMT) attribute.

37. A method for evaluating the supportability of alternative system architecture designs comprising the steps of:
(a) assigning relative weights to each attribute and sub-attribute of a plurality of attributes and sub-attributes of an analytical hierarchy process (AHP) model wherein said plurality of attributes comprises:
a commonality attribute,
a modularity attribute,
a standards based attribute, and
a reliability, maintainability, and testability (RMT) attribute, comprising:
(1) performing pair-wise comparisons of said plurality of attributes and sub-attributes at all levels of said AHP model, and
(2) assigning relative weights to all of said attributes and sub-attributes at all levels of said AHP model;
(b) generating a GPW for each of a plurality of alternative system architecture designs comprising:
(1) performing pair-wise comparisons of each of said plurality of alternative system architecture designs with respect to said all of said attributes and sub-attributes at all levels of said AHP model; and
(c) evaluating said plurality of alternative system architecture designs from a supportability perspective comprising comparing values of said GPWs of said plurality of alternative system architecture designs.

38. The method of claim 37, wherein said commonality attribute comprises:
a plurality of sub-attributes comprising at least one of:
a physical commonality sub-attribute;
a physical familiarity sub-attribute; and
an operational commonality sub-attribute.

39. The method of claim 38, wherein said physical commonality sub-attribute comprises:
a plurality of sub-attributes comprising at least one of:
a hardware (HW) commonality sub-attribute; and
a software (SW) commonality sub-attribute.

40. The method of claim 39, wherein said hardware commonality sub-attribute comprises:
a plurality of sub-attributes comprising at least one of:
a number of unique logical replacement units (LRUs) sub-attribute;
a number of unique fasteners sub-attribute;
a number of unique cables sub-attribute; and
a number of unique standards Implemented sub-attribute.

41. The method of claim 39, wherein said software commonality sub-attribute comprises:
a plurality of sub-attributes comprising at least one of:
a number of unique SW packages implemented sub-attribute;
a number of languages sub-attribute;
a number of compilers sub-attribute;
a average number of SW instantiations sub-attribute; and
a number of unique standards implemented sub-attribute.

42. The method of claim 38, wherein said physical familiarity sub-attribute comprises:
a plurality of sub-attributes comprising at least one of:
a percentage vendors known sub-attribute;
a percentage subcontractors known sub-attribute;
a percentage HW technology known sub-attribute; and
a percentage SW technology known sub-attribute.

43. The method of claim 38, wherein said operational commonality sub-attribute comprises:
a plurality of sub-attributes comprising at least one of:
a percentage of operational functions automated sub-attribute;
a number of unique skill codes required sub-attribute;
an estimated operational training time—initial sub-attribute;
an estimated operational training time—refresh from previous system sub-attribute;
an estimated maintenance training time—initial sub-attribute; and
an estimated maintenance training time—refresh from previous system sub-attribute.

44. The method of claim 37, wherein said modularity attribute comprises:
a plurality of sub-attributes comprising at least one of:
a physical modularity sub-attribute;
a functional modularity sub-attribute;
an orthogonality sub-attribute;
an abstraction sub-attribute; and
an interfaces sub-attribute.

45. The method of claim 44, wherein said physical modularity sub-attribute comprises:
a plurality of sub-attributes comprising at least one of:
an ease of system element upgrade sub-attribute; and
an ease of operating system element upgrade sub-attribute.

46. The method of claim 45, wherein said ease of system element upgrade sub-attribute comprises:
a plurality of sub-attributes comprising at least one of:
a lines of modified code sub-attribute; and
an amount of labor hours for system rework sub-attribute.

47. The method of claim 45, wherein said ease of operating system element upgrade sub-attribute comprises:
a plurality of sub-attributes comprising at least one of:
a lines of modified code sub-attribute; and
an amount of labor hours for system rework sub-attribute.

48. The method of claim 44, wherein said functional modularity sub-attribute comprises:
a plurality of sub-attributes comprising at least one of:
an ease of adding new functionality sub-attribute; and
an ease of upgrade existing functionality sub-attribute.

49. The method of claim 48, wherein said ease of adding new functionality sub-attribute comprises:
a plurality of sub-attributes comprising at least one of:
a lines of modified code sub-attribute; and
an amount of labor hours for system rework sub-attribute.

50. The method of claim 48, wherein said ease of upgrading existing functionality sub-attribute comprises:
a plurality of sub-attributes comprising at least one of:
a lines of modified code sub-attribute; and
an amount of labor hours for system rework sub-attribute.

51. The method of claim 44, wherein said orthogonality sub-attribute comprises:
a plurality of sub-attributes of said orthogonality sub-attribute, said plurality of sub-attributes of said orthogonality sub-attribute comprising at least one of:
a determination of whether functional requirements are fragmented across multiple processing elements and interfaces sub-attribute;
a determination of whether there are throughput requirements across interfaces sub-attribute; and
a determination of whether coimon specifications are identified sub-attribute.

52. The method of claim 44, wherein said abstraction sub-attribute comprises:
a plurality of sub-attributes of said abstraction sub-attribute, said plurality of sub-attributes of said abstraction sub-attribute comprising at least one of:
a determination of whether the system architecture provides an option for information hiding sub-attribute;

53. The method of claim 44, wherein said interfaces sub-attribute comprises:
a plurality of sub-attributes comprising at least one of:
a number of unique interfaces per system element sub-attribute;
a number of different networking protocols sub-attribute;
an explicit versus implicit interfaces sub-attribute;
a determination of whether the architecture involves implicit interfaces sub-attribute; and
a number of cables in the system sub-attribute.

54. The method of claim 37, wherein said standards based attribute comprises:
a plurality of sub-attributes comprising at least one of:
an open systems orientation sub-attribute; and
a consistency orientation sub-attribute.

55. The method of claim 54, wherein said open systems orientation sub-attribute comprises:
a plurality of sub-attributes comprising at least one of:
an interface standards sub-attribute;
a HW standards sub-attribute; and
a software standards sub-attribute.

56. The method of claim 55, wherein said interface standards sub-attribute comprises:
a plurality of sub-attributes comprising at least one of:
a number of interface standards/number and number of Interfaces sub-attribute;
a determination of multiple vendors (greater than 5) existing for products based on standards sub-attribute;
a multiple business domains apply/use standard (Aerospace, Medical, Telecommunications) sub-attribute; and
a standard maturity sub-attribute.

57. The method of claim 55, wherein said hardware standards sub-attribute comprises:
a plurality of sub-attributes comprising at least one of:
a number of form factors and number of LRUs sub-attribute;
a multiple vendors (greater than 5) exist for a products based on standards sub-attribute;
a multiple business domains apply/use standard (aerospace, medical, telecommunications) sub-attribute; and
a standard maturity sub-attribute.

58. The method of claim 55, wherein said software standards sub-attribute comprises:
a plurality of sub-attributes comprising at least one of:
a number of proprietary & unique operating systems sub-attribute;
a number of non-std databases sub-attribute;
a number of proprietary middle-ware sub-attribute; and
a number of non-std languages sub-attribute.

59. The method of claim 54, wherein said consistency orientation sub-attribute comprises:
a plurality of sub-attributes comprising at least one of:
a common guidelines for implementing diagnostics and PM/FL sub-attribute; and
a common guidelines for implementing OMI sub-attribute.

60. The method of claim 37, wherein said RMT attribute comprises:
a plurality of sub-attributes comprising at least one of:
a reliability sub-attribute;
a maintainability sub-attribute; and
a testability sub-attribute.

61. The method of claim 60, wherein said reliability sub-attribute comprises:
a plurality of sub-attributes comprising at least one of:
a fault tolerance sub-attribute; and
a critical points of delicateness system loading sub-attribute.

62. The method of claim 61 wherein said fault tolerance sub-attribute comprises:
a plurality of sub-attributes comprising at least one of:
a percentage of mission critical functions with single points of failure sub-attribute; and
a percentage of safety critical functions with single points of failure sub-attribute.

63. The method of claim 61 wherein said critical points of delicateness system loading sub-attribute comprises:
a plurality of sub-attributes comprising at least one of-.
a percentage of processor loading sub-attribute;
a percentage of memory loading sub-attribute; and
a percentage of network loading sub-attribute.

64. The method of claim 63 wherein said percentage memory loading sub-attribute criticality assessment sub-attribute comprises a criticality assessment sub-attribute.

65. The method of claim 63 wherein said percentage network loading sub-attribute comprises a criticality assessment sub-attribute.

66. The method of claim 60, wherein said maintainability sub-attribute comprises:
a plurality of sub-attributes comprising at least one of:
an expected mean time to replacement (MTTR) sub-attribute;
a maximum fault group size sub-attribute;
a determination of whether system is operational during maintenance sub-attribute; and
an accessibility sub-attribute.

67. The method of claim 66, wherein said accessibility sub-attribute comprises:
a plurality of sub-attributes comprising at least one of:
a space restrictions determination sub-attribute;
a special tool requirements determination sub-attribute; and
a special skill requirements determination sub-attribute.

68. The method of claim 60, wherein said testability sub-attribute comprises:
a plurality of sub-attributes comprising at least one of:
a BIT Coverage sub-attribute;
an error reproducibility sub-attribute;
an online testing sub-attribute; and
an automated input/stimulation insertion sub-attribute.

69. The method of claim 68 wherein said error reproducability sub-attribute comprises:
a plurality of sub-attributes comprising at least one of:
a logging/recording capability sub-attribute; and
a determination of whether system state at time of system failure can be created sub-attribute.

70. The method of claim 68 wherein said online testing sub-attribute comprises:
a plurality of sub-attributes comprising at least one of:
a determination of whether system is operational during external testing sub-attribute; and
an ease of access to external testpoints sub-attribute.

71. The method of claim 37, wherein said step (a) further comprises:
(3) performing sensitivity analysis of said pair-wise comparisons.

72. A computer program product (CPP) for evaluating system architecture designs using an analytic hierarchy process (AHP) model, said CPP embodied on a computer readable medium having program logic stored therein, comprising:
means for enabling a processor to assign relative weights to each attribute and sub-attribute of a plurality of attributes and sub-attributes of an analytical hierarchy process (AHP) model wherein said plurality of attributes comprises:
a commonality attribute,
a modularity attribute,
a standards based attribute, and
a reliability, maintainability, and testability (RMT) attribute, comprising:
means for enabling the processor to perform pair-wise comparisons of DOTs said plurality of attributes and sub-attributes at all levels of said AHP model, and
means for enabling the processor to assign relative weights to all of said attributes and sub-attributes at all levels of said AHP model;
means for enabling the processor to generate a GPW for each of a plurality of alternative system architecture designs comprising:
means for enabling the computer to perform pair-wise comparisons of each of said plurality of alternative system architecture designs with respect to said all of said attributes and sub-attributes at all levels of said AHP model; and
means for enabling the computer to evaluate said plurality of alternative system architecture designs from a supportability perspective comprising comparing values of said GPWs of said plurality of alternative system architecture designs.
